(19) United States
(12) Patent Application Publication
(10) Pub. No.: US 2008/0261851 A1
(43) Pub. Date: Oct. 23, 2008

(54) PACKAGING SYSTEM FOR DETERGENTS OR CLEANSERS

(76) Inventors: Wolfgang BARTHEL, Langenfeld (DE); Salvatore FILECCIA, Oberhausen (DE); Pavel GENTSCHEV, Monheim (DE); Christian NITSCH, Dusseldorf (DE); Ulrich PEGELOW, Dusseldorf (DE); Ulf Arno TIMMANN, Koln (DE)

Correspondence Address: PAUL & PAUL, 2000 MARKET STREET, PHILADELPHIA, PA, 19103-3229, US

(21) Appl. No.: 11/877,448

(22) Filed: Oct. 23, 2007

Related U.S. Application Data
(63) Continuation of application No. PCT/EP2006/002999, filed on Apr. 1, 2006.

(30) Foreign Application Priority Data
Apr. 27, 2005 (DE) 10 2005 025 690.2

(51) Int. Cl. C11D 17/00

(52) U.S. Cl. 510/297

(57) ABSTRACT

Packaging systems for detergent or cleanser dosing units comprising: a) a primary packaging system in the form of a number (n)>2 of water-insoluble bags, each of these bags containing a number (x)>2 of detergent or cleanser dosing units, and; b) a secondary packaging system in the form of a water-insoluble bag that contains the (n) water-insoluble bags of the first packaging system. The inventive packaging systems are suited for increasing the stability of the detergent or cleanser dosing units contained therein.

### CROSS-REFERENCE TO RELATED APPLICATIONS

This application is a continuation under 35 U.S.C. §365(c) and 35 U.S.C. §120 of International Application No. PCT/EP2006/002999, filed Apr. 1, 2006. This application also claims priority under 35 USC. §119 of German Patent Application No. DE 10 2005 025 690.2, filed Apr. 27, 2005. Both the International Application and the German Application are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The subject of the present invention is a packaging system for detergents or cleansers, especially a packaging system for pre-measured unit quantities of detergents or cleansers.

Detergents or cleansers are currently available to consumers in many forms. Aside from detergent powders and granulations, the supply also includes, for instance, concentrated detergents in the form of extruded or tableted compositions. These solid, concentrated or compressed market forms are distinguished by a reduced volume per unit, and so reduce the costs of packaging and transportation. The detergent or cleanser tablets in particular also meet the consumers' desire for simple measurement. The corresponding agents have been described comprehensively in the relevant art. Along with the advantages mentioned, though, compacted detergents or cleansers also have several disadvantages. Tableted market forms are often distinguished by delayed disintegration because of their high compression, and thus by delayed release of their contents. Numerous technical solutions have been disclosed in the patent literature to solve this “conflict” between adequate tablet hardness and short disintegration times. Here, for instance, we note the use of tablet disintegrants. These accelerators of disintegration are added to the tablets along with the substances active as detergents or cleansers. As a general rule they do not themselves exhibit any detergent or cleansing activity, and so increase the complexity and cost of those agents. A further disadvantage of tableting of mixtures of active substances, especially mixtures that contain substances with detergent or cleansing activity, is the inactivation of the active substances they contain by the compaction pressure in tableting. The active substances can also be inactivated through chemical reactions as a result of the increased areas of contact of the ingredients due to tableting.

(2) Description of Related Art, Including Information Disclosed Under 37 C.F.R. §§1.97 and 1.98

Solid or liquid detergents or cleansers having water-soluble or water-dispersible packaging have been described increasingly in recent years as alternatives to the separate or compacted detergents or cleansers. These agents are, like the tablets, characterized by simplified measurement, as they can be added to the washing machine or dishwasher with their packaging. At the same time, they make it possible to produce liquid or powdered detergents or cleansers distinguished by better dissolution and faster activity than the compacts.

For instance, EP 1 314 654 A2 (Unilever) discloses a domed pouch with a holding chamber that contains a liquid.

On the other hand, the subject of WO 01/83657 A2 (Procter & Gamble) is bags containing two particulate solids in a holding chamber. They are in fixed regions and do not mix with each other.

Aside from packages having just one holding chamber, market forms having more than one holding chamber or more than one product form have also been disclosed in the relevant art.

The subject of European Application EP 1 256 623 A1 (Procter & Gamble) is a kit of at least two bags with different compositions and different appearances. The bags are separate from each other, and are not a compact single product.

International Application WO 02/85736 A1 (Reckitt Benckiser) describes a process for producing multi-chamber bags by gluing two individual chambers together.

Cardboard or other boxes or blister packs are used primarily to package the measured units mentioned above.

For example, European Application EP 1 516 918 A2 (Procter Gamble) discloses a container that preferably has a view window and that contains a group of measured units that can be distinguished by their color or shape.

### BRIEF SUMMARY OF THE INVENTION

The objective of the present application was to provide an optimized packaging system for measured units of detergents or cleansers. This packaging system is intended to be distinguished especially by better storage stability with respect to the action of chemical or physical influences on the measured units. Furthermore, the amount of packaging materials used should be reduced as much as possible while maintaining the stability of the measured units.

That objective was achieved by a packaging system comprising a combination of mutually encompassing water-insoluble packaging systems.

Thus, a first object of the present application is a packaging system for detergents or cleansers comprising
a primary packaging system in the form of a number (n)>2 of water-insoluble bags, in which each of these bags contains a number (x)>2 of measured detergent or cleansing units; and
a secondary packaging system in the form of a water-insoluble bag which contains the (n) water-insoluble bags of the primary packaging system.

To use the measured detergent or cleanser units packaged according to the invention, the consumer opens the water-insoluble bag of the secondary packaging system and removes from it one of the (n)>2 water-insoluble bags of the primary packaging system. Then the consumer can remove from that one of the (x)>2 detergent or cleanser units.

### BRIEF DESCRIPTION OF THE SEVERAL VIEWS OF THE DRAWING(S)

Not Applicable

### DETAILED DESCRIPTION OF THE INVENTION

The water-insoluble bag of the first packaging system and/or of the second packaging system is preferably closed by the consumer before use. The units of detergents or cleansers contained in the water-insoluble bag of the primary packaging system are preferably not separated from each other by other packaging means and are preferably in contact.

Detergents or cleansers in the meaning of the present application are understood to be those detergents or cleansers that are suitable for carrying out a cleaning process, preferably a machine dish-washing process or a machine textile-cleaning process.

If the measured units of detergent or cleanser are units for machine dishwashing, then it is desirable for those units to weigh more than 5 g, preferably between 10 and 40 g, especially preferably between 15 and 30 g, and particularly between 15 and 25 g. It is desirable for the volumes of these units to be less than 50 ml so that they can be added through the metering chamber of the dishwasher, preferably between 10 and 40 ml, especially preferably between 15 and 30 ml, and particularly between 15 and 25 ml.

If, on the other hand, the measured units of detergent or cleanser are units for textile cleansing, then it is preferable for those units to weigh more than 10 g, preferably between 20 and 100 g, especially preferably between 30 and 90 g and particularly between 40 and 80 g. In order that the units can be fed in through the feed chamber of the washing machine, it is preferable for those units to have volumes less than 120 ml, preferably between 20 and 100 ml, especially preferably between 30 and 90 ml, and particularly between 40 and 80 ml.

It has proven to be particularly advantageous with respect to the problems to be solved to raise the number (x) of the measured units contained n the primary packaging system to a number >3. Therefore a packaging system wherein each water-insoluble bag of the primary packaging system contains a number (x)>3, preferably (x)<4, and especially preferably (x)>5 measured units of detergent or cleanser is a preferred object of the present invention.

In a further preferred embodiment, the primary packaging system comprises a number of (n)>3, preferably (n)>4, and especially preferably (n)>5 water-insoluble bags.

The water-insoluble bags of the primary packaging system can have identical dimensions or fillings. Obviously they can also differ in both dimensions and fillings.

A preferred embodiment of the packaging system according to the invention is one wherein the water-insoluble bags of the primary packaging system differ in their fill volumes by less than 50% by volume, preferably by less than 40% by volume, and especially by less than 10% by volume.

A further preferred embodiment of the packaging system according to the invention is one wherein the number (n) of the water-insoluble bags in the primary packaging system and the number (x) of units of measured detergent or cleanser units in each of those bags do not differ by more than 3, preferably by not more than 2, and especially by not more than 1.

Packaging systems according to the invention wherein the primary and/or secondary packaging system have moisture permeation rates of 0.1 g/m2/day to less than 20 g/m2/day when the packaging system is stored at 23° C. and 85% relative equilibrium moisture content is distinguished by improved storage stability of the measured units of detergent or cleanser, and so are preferred.

The packaging system according to the invention is suitable for stabilizing the units of detergent or cleanser which it contains in the chemical and physical sense. Thus, the packaging system does not just protect the active substances contained in the measured units of detergent or cleanser from premature chemical decomposition. Rather, it protects the detergent or cleanser units themselves from rupture or leakage.

It was found, surprisingly, that just packaging a number (x)>2 of the measurement units in the primary packaging system and the subsequent joint production of a number (n) of such primary packaging systems in a common secondary packaging system can reduce the susceptibility of the detergent or cleanser units to rupture or leakage, in comparison with a packaging system that contains all the (x) times (n) detergent or cleanser units in a single packaging system.

This surprising stabilization of the measured units against physical effects (drop or impact tests) such as can occur in transportation and use of these agents cannot be explained merely by use of additional packaging materials. Instead, this effect can also be observed with use of the same amount of packaging material, as long as this packaging material is distributed over a primary and a secondary packaging system in a manner according to the invention.

Stabilization of the measured units of detergents or cleansers against chemical or physical decomposition can be further improved by intentionally modifying the gaseous atmosphere within the primary and secondary packaging systems.

Processes for packaging detergents or cleansers are usually carried out in the ambient atmosphere. Therefore the gas enclosed in the packaging means has a composition corresponding to the composition of the air, or diverging only slightly from it.

In the context of the present invention it is preferred that at least one of the packaging systems according to the invention be filled with a gas having a composition differing from the ambient air. Ambient air is defined in the normal way as a gas mixture containing 78% by volume nitrogen, 21% by volume oxygen, and 1% by volume other gases. A difference, in the sense of the invention, exists if the composition of the gas in the packaging system differs from that of the ambient air either
(a) with respect to an added or missing component; or
(b) with respect to the volume proportion of one of its components, whereby gas mixtures having compositions differing from that of the ambient air by more than 1% by volume of one of its components, preferably by more than 5% by volume, preferably by more than 10% by volume, quite particularly preferably by more than 20% by volume, and particularly by more than 50% by volume are particularly preferred.

In a preferred embodiment, it is not the primary packaging system but the secondary packaging system that is filled with a gas having a composition differing from that of the ambient air.

In a further preferred embodiment, both the primary and the secondary packaging system are filled with a gas having a composition different from that of the ambient air, whereby the composition of the gas in the primary packaging system differs from the composition of the gas in the secondary packaging system.

Packaging systems according to the invention wherein at least one water-insoluble bag of the primary packaging system and/or of the water-insoluble bags of the secondary packaging system is filled with a gas having a composition differing from that of the ambient air are preferred.

Packaging systems according to the invention in which the primary and/or secondary packaging system is/are filled with a gas having a proportion of nitrogen by volume of greater than 80%, preferably greater than 85%, especially preferably above 90%, and particularly above 95% are especially preferred.

Aside from the composition of the gases enclosed in the primary and secondary packaging systems, the chemical and physical stability of the measured detergent or cleanser units can also be increased by the degree of filling of the primary and secondary packaging systems and/or by the pressure of the gases enclosed in the primary and secondary packaging systems.

Thus, for instance, it is preferred according to the invention for the primary and secondary packaging systems to have different degrees of filling. In a preferred embodiment, the primary packaging system has a higher degree of filling than the secondary packaging system. Thus, it is preferred according to the invention for the primary packaging system to have a degree of filling of more than 80% by volume, preferably more than 85% by volume, and especially greater than 90% by volume, while the secondary packaging system has a degree of filling less than 75% by volume, preferably less than 70% by volume and especially less than 60% by volume.

In a particularly preferred embodiment, at least one of the packaging systems has a degree of filling greater than 95% by volume, preferably greater than 97% by volume, and especially above 99% by volume, and quite particularly preferably 100% by volume. Such a degree of filling can, for instance, be accomplished by the water-insoluble bags of the primary packaging system and/or of the secondary packaging system being vacuum-sealed.

Packaging systems, wherein at least one water-insoluble bag of the primary packaging system and/or the water-insoluble bag of the secondary packaging system is vacuum-sealed, are preferred according to the invention.

Conversely, the stability of the detergent or cleanser units contained in the packaging system according to the invention can be increased if the water-insoluble bags of the primary packaging system and/or of the secondary packaging system are inflated.

Packaging systems, wherein at least one water-insoluble bag of the primary packaging system and/or the water-insoluble bags of the secondary packaging system is inflated, are preferred according to the invention.

The degree of filling specified above refers, according to the invention, both to the measured units contained in the particular packaging system and to the gas contained in the particular packaging system. The maximum degree of filling of a packaging system (100% by volume) is understood to be the volume of a packaging system which, if exceeded, will cause reversible or irreversible stretching of the particular packaging system.

The packaging system according to the invention comprises two mutually encompassing water-insoluble bags. “Bags” are designated as sac-like containers distinguished from commercial packaging cartons by flexible sidewalls, that is, by sidewalls that can fold or roll.

Particularly preferably packaging systems according to the invention are distinguished by at least one of the water-insoluble bags of the primary packaging system and/or the water-insoluble bags of the secondary packaging system being a stand-up pouch, a gusseted bag, a satchel bag, or a flowpack.

The measured detergent or cleanser units contained in the packaging system according to the invention are “single-use” units, that is, portions of detergent or cleanser suitable for carrying out a single cleansing process, preferably a machine dishwashing process or a machine textile-washing process. If one such unit is removed from the packaging system, the other units remain in the packaging system until the next usage. It is preferable for the primary packaging system and/or the secondary packaging system to be provided with a reclosable opening to protect the units remaining in the packaging system.

Packaging systems according to the invention wherein at least one of the water-insoluble bags of the primary packaging system and/or the water-insoluble bags of the secondary packaging system has a reclosable opening are therefore preferred according to the invention.

The packaging system according to the invention is basically suitable for all measured detergent or cleanser units known to those skilled in the art. A measured detergent or cleanser unit is defined as a portioned quantity of a detergent or cleanser that is suitable for performing one washing or cleansing process, such as in a dishwashing machine or a textile-washing machine, and which is used up in the course of that washing or cleansing process. Typical measured units for machine dishwashing have volumes between 12 and 40 ml, preferably between 14 and 30 ml and especially between 16 and 25 ml.

Production of the measured units of detergent or cleanser can be accomplished by processes and methods known to those skilled in the art. The especially preferred measured units include not only the compacted forms, especially tablets, and extrudates, but also the water-soluble containers, especially deep-drawn or injection-molded containers and water-soluble film bags.

In a first preferred embodiment, the measured detergent or cleanser units packaged according to the invention are compressed moldings, preferably tablets of detergent or cleanser.

To make tablets, particulate premixes are compressed in a “die” between two punches into a solid compaction. This process, which is briefly called “tableting” in the following, occurs in four steps: measuring, compression, plastic deformation, and ejection.

First, the premix is introduced into the die, with the amount of fill and, thus, the weight and shape of the resulting molding being determined by the position of the lower punch and the shape of the compression mold. It is preferable for constant metering, even at high throughputs of the molded tablets, to be achieved by volumetric metering of the premix. In the further course of tableting, the upper punch contacts the premix and moves farther toward the lower punch. In this compression, the particles of the premix are forced closer together so that the void volume within the filling between the punches decreases continuously. Plastic deformation begins past a certain position of the upper punch (and thus beyond a certain pressure on the premix). In that process, the particles flow together and the molding takes its shape. Depending on the physical properties of the premix, some of the premix particles are crushed, and the premix is sintered at still higher pressures. With increasing press speed, and so higher production rates, the elastic deformation phase is increasingly shortened, so that the resulting molding can have more or less voids. In the last step of tableting, the finished molding is ejected from the die by the lower punch and carried away by subsequent transport means. At this time only the weight of the molding is finally established, because the molding can still change in size and shape because of physical processes (elastic relaxation, crystallographic effects, cooling, etc.).

The tableting is done in ordinary commercial tablet presses, which can basically be equipped with single or double punches. In the latter case, it is not only the upper punch that is used to apply pressure, but the lower punch also moves toward the upper one while the upper one is forced down. Eccentric tablet presses are used preferably for small amounts of production. In those, the punch or punches are mounted on an eccentric disc which, in turn, moves around an axis at a defined peripheral speed. The movement of this press punch is comparable with the operation of an ordinary four-stroke engine. The compression can be accomplished with one each, upper and lower punch, but it is also possible to mount multiple punches on an eccentric disk, with the number of dies increased correspondingly. The throughputs of eccentric presses vary, depending on the type, from a few hundred to a maximum of 3,000 tablets per hour.

In eccentric presses, the lower punch is generally not moved during the compression process. One consequence of that is that the resulting tablets exhibit hardness gradients. That is, they are harder in the regions that were nearer the upper punch than in the regions nearer the lower punch.

Rotary tablet presses are used for higher throughputs. In those, a larger number of dies is arranged in a circle on a die table. The number of dies varies from 6 to 55, depending on the model, and even more dies are commercially available. Each die on the die table has an upper punch and a lower punch. Again, the compression force can be developed actively by only the upper or lower punch, or by both punches. The die table and the punches move about a common vertical axis. By means of curved rail-like tracks the punches are moved, during a rotation, into positions for filling, compression, plastic deformation and ejection. At the places where especially strong upward or downward movements of the punches are needed (filling, compression, ejection), these curved tracks are supported by additional low-pressure pieces, low-tension rails and stripping tracks. The dies are filled from a solidly placed feed system, the “feed shoe,” which is connected to a supply tank. The compression force on the premix is individually adjustable for the upper and lower punches along the compression paths. The pressure is developed as heads of the punches roll past adjustable pressure rolls.

Rotary presses can also be provided with two-feed shoes to increase throughput. Then the tablets need to pass only through a semicircle for production. Multiple feed shoes are arranged successively to make two-layer and multi-layer moldings, without the lightly compressed first layer being ejected before further filling. It is also possible to produce coated and point tablets in this way by suitable conduct of the process. Those tablets have an onion-ring structure. In the case of point tablets, the upper side of the core or of the core layer is not covered, and so remains visible. Rotary tablet presses can also be equipped with single or multiple dies, so that, for instance, an outer circle of 50 holes and an inner circle of 35 holes can be used simultaneously for pressing. Modern rotary tablet presses have throughputs of more than a million moldings per hour.

The detergent and cleanser moldings have high stability after pressing. The breaking strength of cylindrical moldings can be determined by measuring the diametric breaking stress. as can be determined from

$$σ = \frac{2 P}{π D t}$$

Here σ stands for the diametric breaking force (diametral fracture stress, DFS) in Pa; P is the force in N that produces the force on the molding that causes the molding to break, D is the molding diameter in meters, and t is the thickness of the molding.

Obviously the tablets can likewise be made in multiple phases, especially in multiple layers, in the context of this invention. The moldings can be made in predetermined shapes and sizes. Practically all reasonably manageable forms can be considered as forms, such as plates, rods or bar shapes, cubes, or squares, and corresponding spatial elements with flat side surfaces and, in particular, cylindrical forms with circular or oval cross-sections. This last form includes the presentation forms of tablets up to compact cylindrical segments with a height-to-diameter ratio greater than 1.

The spatial form of a different embodiment of the molding has its dimensions adapted to the measuring chambers of commercial household washing machines or to the measuring chambers of commercial dishwashing machines, so that the moldings can be measured directly into the measuring chamber without a metering aid, where they dissolve during the rinsing process, or from where they are released during the cleaning process. Obviously it is also possible to use detergent or cleanser moldings with metering aids without problems.

It is especially preferable for the detergent or cleanser moldings to have a cavity. This cavity can be a trough or a penetration. Those cavities that pass through the molding and accordingly have at least two, preferably exactly two, openings on the surface of the molding are designated as penetrations. Those penetrations are preferred for which the openings connect two opposite side of the molding. The resulting moldings can be called ring moldings or ring tablets.

In a preferred embodiment, the troughs or penetrations described above are filled. Suitable fillings include solids, for example, as well as liquids or solidifying melts. The troughs or penetrations can also be filled with one of the deep-drawn or injection-molded containers described below. Detergent or cleanser moldings having troughs closed with a water-soluble or water-dispersible film that is preferably adhesive to the detergent or cleanser molding are especially preferred.

Those packaging systems, wherein the detergent or cleanser measured units comprise a pressed molding and an adhesive water-soluble film adherent to those moldings, are preferred.

As mentioned, multi-phase measured units can be produced in a simple manner with the adherent combination of detergent or cleanser moldings, preferably detergent or cleanser tablets. They comprise not only a solid but, for example, also a flowable composition, preferably a liquid or a gel, and are completely soluble in water. Such measured units combine the advantages of premeasured cleanser portions with the advantages of flowable, easily soluble cleansers.

However, the adhesive combination of molding and water-soluble film is the basis for production of these measured units, and the stability of the sealing seam between the molding and the water-soluble film becomes very important. It was established that that stability of moldings containing sodium percarbonate and of moldings containing nonionic surfactants, in particular, can be improved by the packaging system according to the invention. This packaging system is particularly suitable for stabilizing the sealing seam between moldings containing detergent and cleanser and the adhesively bonded water-soluble films.

Therefore those packaging systems are especially preferred according to the invention in which the measured units comprising cleanser or detergent contain more than 4% by weight, preferably more than 6% by weight, and especially more than 8% by weight of sodium percarbonate, based on the total weight of the contained substances with detergent or cleansing action, whereby the detergent or cleanser measured units preferably comprise a compressed molding and a water-soluble film adhesively bonded to that molding.

Packaging systems wherein the detergent or cleanser units comprise 0.5 to 8% by weight nonionic surfactants, based on the total weight of the detergent or cleanser substances contained, preferably 1 to 7% by weight, and especially preferably 2 to 6% by weight, whereby the measured detergent or cleanser units preferably comprise a pressed molding and a water-soluble film adhesively bonded to that molding are further preferred.

In a second preferred embodiment, the measured detergent or cleanser units packaged according to the invention are filled deep-drawn containers. In the context of the present invention, those containers that are obtained by deep drawing of a first film-like envelope material are designated as deep-drawn containers or deep-draw forms. The deep drawing is accomplished preferably by placing the envelope material over a receiving cavity and forming the envelope material into this receiving cavity by the action of pressure and/or vacuum. The envelope material can be pretreated before or during the shaping by the action of heat and/or solvent and/or conditioning by relative humidities and/or temperatures different from the ambient conditions. The pressure action can be accomplished with two pieces of a die which are like positives and negatives of each other. A film placed between them is formed when they are forced together. However, the action of compressed air and/or the weight of the film itself and/or the weight of an active substance placed on the top of the film are also suitable pressure forces.

After deep-drawing, the deep-drawn envelope materials are preferably held within the receiving cavity by use of a vacuum and their spatial form produced by the deep-drawing process is fixed. The vacuum is preferably applied continuously from the deep-drawing to the filling and preferably to sealing and especially to the separation of the receiving chambers. It is, to be sure, also possible to apply a discontinuous vacuum with comparable success, such as by deep-drawing the receiving cavities and (after an interruption) before and during filling of the receiving cavities. The continuous or discontinuous vacuum can also vary in its intensity and, at the beginning of the process, for instance (for deep-drawing of film), can have higher values than at the end of the process (on filling or sealing or separation).

As mentioned previously, the envelope material can be pretreated by the action of heat before or during forming into the receiving cavities of the dies. The envelope material, preferably a water-soluble or water-dispersible polymeric film is heated for up to 5 seconds, preferably for 0.1 to 4 seconds, especially preferably for 0.2 to 3 seconds and particularly for 0.4 to 2 seconds to temperatures above 60° C., preferably above 80° C., especially preferably between 100 and 120° C., and particularly to temperatures between 105 and 115° C. It is desirable to cool the dies used and the receiving cavities within those dies to remove that heat and also, in particular, to remove the heat introduced into the deep-drawn receiving cavities by the agent filled into them (e.g., melts). The cooling is preferably done at temperatures below 20° C., preferably below 15° C., especially preferably at temperatures between 2 and 14° C., and particularly at temperatures between 4 and 12° C. The cooling is preferably done continuously from the beginning of the deep-drawing process until sealing and separation of the receiving chambers. Cooling fluids, preferably water, circulated in special cooling lines within the dies are especially suitable for cooling.

This cooling, like the previously described continuous or discontinuous application of a vacuum, has the advantage of preventing the deep-drawn containers shrinking back after deep drawing. This does not merely improve the appearance of the product of the process, but also prevents the material filled into the receiving chambers getting over the edge of the receiving chambers, as into the sealing regions of the chambers. That avoids problems in sealing the filled chambers.

For the deep-drawing process, one can distinguish between processes in which the envelope material is conducted horizontally to a forming station and, from there, horizontally to filling and/or sealing and/or separation, and processes in which the envelop material is conducted over a continuously rotating die-shaping roll (perhaps optionally with a counter-rotating roll of male dies which carry the upper forming punches to the cavities of the die-forming roll. The former variant of the flat-bed process can be operated either continuously or discontinuously. The process variant using a forming roll is generally operated continuously. All the deep-drawing processes mentioned are suitable for producing the means preferred according to the invention. The receiving cavities in the dies can be arranged “in line” or displaced.

The deep-drawn bodies can have one, two, three or more receiving cavities. These receiving cavities can be arranged side-by-side and/or one over the other in the deep-drawing part. Preferably the individual receiving chambers of the deep-drawn bodies are filled with different materials. It is especially preferable to fill at least one receiving chamber of a deep-drawn body with a liquid, while at least one other receiving chamber of this deep-drawn body is filled with a solid.

In a further preferred embodiment, the measured units of detergent or cleanser packaged according to the invention are injection molded containers. Injection molding designates the shaping of a molding compound so that the compound contained in a compound cylinder, enough for more than one injection process, is plastically softened by heat and flows under pressure into the cavity of a previously closed mold. The process is used primarily for non-curable molding materials which solidify by cooling in the mold. Injection molding is a very economical modern process for making stress-free molded objects, and is especially suitable for automated mass production. In practical operation, one heats the thermoplastic molding compound (powder, granules, cubes, pastes, and the like) until it liquefies (up to 180° C.) and then injects it under high pressure (up to 140 MPa) into closed water-cooled molds consisting of two pieces, the female mold (previously called the die) and the core (previously called the male mold), where they cool and solidify. Piston and auger injection-molding machines can be used. Suitable molding compounds (injection molding compounds) include water-soluble polymers such as the above-mentioned cellulose ethers, pectins, polyethylene glycols, polyvinyl alcohols, polyvinylpyrrolidones, alginates, gelatins or starches.

Packaging systems preferred according to the invention are distinguished by the units containing the detergent or cleanser being filled water-soluble or water-dispersible containers, preferably filled deep-drawn or injection-molded containers.

The previously described means according to the invention contain substances with detergent and cleansing actions, preferably detergent and cleansing-active substances from the group of detergent builders, surfactants, polymers, bleaching agents, bleach activators, enzymes, glass corrosion inhibitors, corrosion inhibitors, disintegrants, fragrances and perfume carriers. These and other preferred ingredients of the means according to the invention are described in more detail in the following.

The builders include, in particular, the zeolites, silicates, carbonates, organic cobuilders, and, where there are no ecological biases against their use, also phosphates.

Crystalline laminar silicates of the general formula NaMSixO2x+1.yH2O in which M represents sodium or hydrogen, x is a number from 1.9 to 22, preferably 1.9 to 4, with 2, 3 or 4 being particularly preferred values for x, and y stands for a number from 0 to 33, preferably 0 to 20, are particularly preferable for use. The crystalline laminar silicates having the formula NaMSixO2x+1.yH2O are sold, for example by the company Clariant GmbH (Germany) under the trade-name Na-SKS. Examples of these silicates are Na-SKS-1 (Na2Si22O45.xH2O, Kenyaite), Na-SKS-2 (Na2Si14O29.xH2O), (magadite), Na-SKS-3 (Na2Si8O17.xH2O) or Na-SKS-4 (Na2Si4O9.xH2O, makatite).

Crystalline laminar silicates having the formula NaMSixO2x+1.yH2O are particularly suitable for the purposes of the present invention. In particular, both β- and δ-sodium disilicates, Na2Si2O5.yH2O, are preferred and also, in particular, Na-SKS-5 (α-Na2Si2O5), Na-SKS-7 (β-Na2Si2O5), (natrosilite), Na-SKS-9 (NaHSi2O5.H2O), Na-SKS-10 (NaHSi2O5.3H2O, kanemite), Na-SKS-11 (t-Na2Si2O5) and Na-SKS-13 (NaHSi2O5), and especially Na-SKS-6 (δ-Na2Si2O5) are preferred.

Detergent or cleansing agents preferably contain the crystalline laminar silicate having the formula NaSixO2x+1.yH2O in proportions of 0.1 to 20% by weight, of 0.2 to 15% by weight, and especially of 0.4 to 10% by weight, based in each case on the total weight of the agent.

Amorphous sodium silicates with a Na2O:SiO2 ratio of 1:2 to 1:3.3, preferably 1:2 to: 2.8, and especially preferably 1:2 to 1:2.6 are also usable. They are preferably slow-dissolving and exhibit secondary washing effects. The delay in dissolution compared to ordinary amorphous sodium silicates can be produced in various ways, such as by surface treatment, compounding, compacting/compression or over-drying. In the context of this invention the concept “amorphous” is understood to mean that the silicates show no sharp X-ray reflections such as are typical of crystalline substances in X-ray diffraction experiments, in every case one or more maxima of the scattered X-ray radiation, indicating that the diffraction angle has a range of several degrees.

Alternatively or in combination with the amorphous sodium silicates previously mentioned, silicates for which the silicate particles show stronger or even sharp diffraction maxima are used. This must be interpreted as indicating that the products have microcrystalline regions with sizes of ten to some hundreds of nm. Values up to a maximum of 50 nm are preferred, and particularly up to a maximum of 20 nm. Such X-ray amorphous silicates likewise exhibit delayed dissolution compared with commercial water glasses. Compressed/compacted amorphous silicates, compounded amorphous silicates, and over-dried X-ray amorphous silicates are particularly preferred.

In the context of the present invention it is preferable for this/these silicate/silicates, preferably alkali silicates, especially preferably crystalline or amorphous alkali disilicates, to be used in detergent or cleansing agents in proportions of 3 to 60% by weight, preferably of 8 to 50% by weight, and especially of 20 to 40% by weight, based in each case on the weight of the detergent or cleansing agent.

It is also possible, of course, to use the generally known phosphates as builder substances as long as such use does not have to be avoided for ecological reasons. Among the multitude of commercially available phosphates, the alkali metal phosphates are the most important in the detergent and cleanser industry, with pentasodium or pentapotassium triphosphates (sodium or potassium tripolyphosphates) particularly preferred and most important in the detergent or cleanser industry.

“Alkali metal phosphate” is the summary designation for the alkali metal salts (especially sodium and potassium salts) of the various phosphoric acids, among which one can distinguish metaphosphoric acids, (HPO3)n and orthophosphoric acids, H3PO4, as well as representatives of higher molecular weights. The phosphates combine several advantages: they act as alkali carriers, prevent lime deposits on machine parts and lime encrustations in fabrics, and also contribute to cleaning power.

The phosphates of special technical importance are pentasodium triphosphate, Na5P3O10 (sodium tripolyphosphate) and the corresponding potassium salt, pentapotassium triphosphate (potassium tripolyphosphate). The sodium potassium tripolyphosphates are also preferred for use according to the invention.

If phosphates are used as active substances for laundry or cleaning in detergent or cleansing agents in the context of the present invention, then preferred agents contain this/these phosphate(s), preferably alkali metal phosphate(s), especially preferably pentasodium or pentapotassium triphosphate (sodium or potassium tripolyphosphate) in proportions of 5 to 80% by weight, preferably of 15 to 75% by weight and especially of 20 to 70% by weight, based in each case on the weight of the detergent or cleanser.

The alkali carriers are other builders. Alkali carriers are, for example, alkali metal hydroxides, alkali metal carbonates, alkali metal bicarbonates, alkali metal sesquicarbonates, the alkali silicates mentioned, alkali metasilicates, and mixtures of the aforementioned substances, with the alkali carbonates, especially sodium carbonate, sodium bicarbonate or sodium sesquicarbonate used by preference. A builder system containing a mixture of tripolyphosphate and sodium carbonate is especially preferred. A builder system containing a mixture of tripolyphosphate and sodium carbonate and sodium disilicate is also especially preferred. It is preferable to use the alkali metal hydroxides only in low proportions, preferably in proportions less than 10% by weight, preferably less than 6% by weight, especially preferably less than 4% by weight, and particularly less than 3% by weight, based in each case on the total weight of the detergent or cleanser, because of their poor chemical compatibility with the other ingredients of detergents or cleansers, compared with other builder substances. Agents which contain less than 0.5% by weight alkali metal hydroxide, and especially none, are especially preferred.

It is particularly preferable to use carbonate(s) and/or bicarbonate(s), preferably alkali carbonate(s), in proportions of 2 to 50% by weight, preferably 5 to 40% by weight, and especially 7.5 to 30% by weight, based in each case on the weight of the detergent or cleanser. Preferred agents contain, based on the weight of the detergent or cleanser, less than 20% by weight, preferably less than 17% by weight, preferably less than 13% by weight, and particularly less than 9% by weight carbonate(s) and/or bicarbonate(s), preferably alkali carbonate(s) and especially preferably sodium carbonate.

Particular examples of cobuilders include polycarboxylates/polycarboxylic acids, polymeric polycarboxylates, aspartic acid, polyacetals, dextrins, other organic cobuilders (see below) and phosphonates. These classes of materials are described in the following.

The polycarboxylic acids, for example, are organic builder materials that can be used in the form of the free acids and/or their sodium salts. Polycarboxylic acids are understood to mean those carboxylic acids bearing more than one acid function. Examples include citric acid, adipic acid, succinic acid, glutaric acid, malic acid, tartaric acid, maleic acid, fumaric acid, sugar acids, aminocarboxylic acids, and nitrilotriacetic acid (NTA), as long as there is no objection to their use for ecological reasons, as well as mixtures of them. The free acids possess not only their builder action but typically also the property of an acidifying component, thus serving also to adjust a lower and milder pH of detergent or cleansing agents. Citric acid, succinic acid, glutaric acid, adipic acid, gluconic acid, and arbitrary mixtures of those must be mentioned in particular.

Other polycarboxylates are suitable as builder materials. They are, for example, the alkali metal salts of polyacrylic acid or polymethacrylic acid, such as those having a relative molecular weight of 500 to 70,000 g/mole.

In the sense of this document, the molecular weights stated for the polymeric polycarboxylates are weight-average molecular weights Mw of the particular acid forms. They are determined essentially by gel permeation chromatography (GPC) using a UV detector. They are measured in comparison with an external polyacrylic acid standard which yields realistic molecular weight values because of its structural relation with the polymers being investigated. Those values differ distinctly from the molecular weight figures when polystyrenesulfonic acids are used as the standard. The molecular weights measured with polystyrene sulfonic acids are, as a rule, distinctly higher than the molecular weights reported in this document.

Suitable polymers are, in particular, polyacrylates, which preferably have a molecular weight of 2,000 to 20,000 g/mole. The short-chain polyacrylates, having molecular weights of 2,000 to 10,000 g/mole and especially preferably 3,000 to 5,000 g/mole, are preferred because of their better solubility.

Copolymeric polycarboxylates are also suitable, especially copolymers of acrylic acid with methacrylic acid and of acrylic acid or methacrylic acid with maleic acid. The copolymers of acrylic acid with malic acid that contain 50 to 90% by weight acrylic acid and 50 to 10% by weight maleic acid have proven to be particularly suitable. Their relative molecular weights, based on the free acids, are generally 2,000 to 70,000 g/mole, preferably 20,000 to 50,000 g/mole and particularly 30,000 to 40,000 g/mole.

The (co)polymeric polycarboxylates can be used either as powders or as aqueous solutions. The concentrations of (co)polymeric polycarboxylates in detergent or cleansing agents are preferably 0.5 to 20% by weight, especially 3 to 10% by weight.

The polymers can also contain allylsulfonic acids such as allyloxybenzenesulfonic acid and methallylsulfonic acid as monomers to improve their water solubility.

Biodegradable polymers of more than two different monomer units are also particularly preferred, such as those containing as monomers salts of acrylic acid and maleic acid and vinyl alcohol or vinyl alcohol derivatives, or, as monomers, salts of acrylic acid and of 2-alkylallylsulfonic acid and sugar derivatives.

Other preferred copolymers are those that have as monomers preferably acrolein and acrylic acid/acrylic acid salts or acrolein and vinyl acetate.

Polymeric aminodicarboxylic acids, their salts, or their precursors must also be mentioned as preferred builder substances. Polyaspartic acids or their salts are particularly preferred.

Other suitable builder substances are polyacetals, which can be obtained by reaction of dialdehydes with polyol carboxylic acids having 5 to 7 C atoms and at least 3 hydroxyl groups. Preferred polyacetals are obtained from dialdehydes such as glyoxal, glutaraldehyde, terephthalaldehyde and mixtures of them, and from polyol carboxylic acids such as gluconic acid and/or glucoheptonic acid.

Other suitable organic builder substances are dextrins, such as oligomers or polymers of carbohydrates that can be obtained by partial hydrolysis of starches. The hydrolysis can be done by the usual processes, such as those catalyzed by acid or by enzymes. Hydrolysis products with average molecular weights in the range of 400 to 500,000 g/mole are preferred. A polysaccharide having a dextrose equivalent (DE) in the range of 0.4 to 40, and especially 2 to 30, is preferred. The DE is a useful measure of the reducing effect of a polysaccharide in comparison with dextrose, which has a DE of 100. Maltodextrins having a DE of 3 to 20 and dry glucose syrups with a DE of 20 to 37, as well as yellow dextrins and white dextrins with higher molecular weights in the range of 2,000 to 30,000 g/mole are usable.

The oxidized derivatives of such dextrins are products of their reaction with oxidizing agents that can oxidize at least one alcohol function of the saccharide ring to the carboxylic acid function.

Oxydisuccinates and other derivatives of disuccinates, preferably ethylenediamine disuccinate, are other suitable cobuilders. It is preferred to use ethylenediamine-N,N′-disuccinate (EDDS) in the form of its sodium or magnesium salt. Glycerol disuccinate and glycerol trisuccinate are also preferred in this connection. Suitable proportions for use in formulations containing zeolites or silicates are 3 to 15% by weight.

Examples of other usable organic cobuilders are acetylated hydroxycarboxylic acids or their salts, which can also, if preferred, be in the lactone form, and which contain at least 4 carbon atoms, at least one hydroxyl group, and no more than two acid groups.

Furthermore, all compounds that are able to form complexes with alkaline earth ions can be used as builders.

The group of surfactants includes nonionic, anionic, cationic and amphoteric surfactants.

All the nonionic surfactants known to those skilled in the art can be used as nonionic surfactants. Alkylglycosides having the general formula RO(G)ₓ, in which R is a primary aliphatic group with a chain that is straight or methyl-branched, especially in the 2 position, with 8 to 22, preferably 12 to 18 C atoms and G is the symbol for a glycose unit having 5 or 6 C atoms, preferably glucose, are examples of suitable nonionic surfactants. The degree of oligomerization, x, which indicates the distribution of monoglycosides and oligoglycosides, is any desired number between 1 and 10. It is preferably 1.2 to 1.4.

Another class of nonionic surfactants used preferably, either as individual nonionic surfactants or in combination with other nonionic surfactants, is made up of alkoxylated, preferably ethoxylated or ethoxylated and propoxylated fatty acid alkyl esters, preferably with 1 to 4 carbon atoms in the alkyl chain.

Nonionic surfactants of the amine oxide type, such as N-cocoalkyl-N,N-dimethylamine oxide and N-tallowalkyl-N,N-dihydroxylethylamine oxide, and the fatty acid alkalolamides can also be suitable. The proportion of these nonionic surfactants is preferably not greater than that of the ethoxylated fatty alcohols, and particularly not greater than half of that.

Other suitable surfactants are polyhydroxyfatty acid amides of the formula

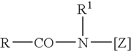

in which R stands for an aliphatic acyl group with 8 to 22 carbon atoms, R¹ stands for hydrogen or an alkyl group or a hydroxyalkyl group with 1 to 4 carbon atoms, and [Z] stands for a linear or branched polyhydroxyalkyl group with 3 to 10 carbon atoms and 3 to 10 hydroxyl groups. The polyhydroxy fatty acid amides are known materials that can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds of the formula

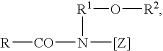

in which the R stands for a linear or branched alkyl or alkenyl group with 7 to 12 carbon atoms, R¹ stands for a linear, branched or cyclic alkyl group or an aryl group with 2 to 8 carbon atoms, and R² stands for a linear, branched or cyclic alkyl group or an aryl group or an oxyaryl group with 1 to 8 carbon atoms, with C₁₋₄ alkyl groups or phenyl groups preferred, and [Z] stands for a linear polyhydroxyalkyl group, the alkyl chain of which is substituted with at least two hydroxyl groups, or alkoxylated, preferably ethoxylated or propoxylated derivates of that group.

[Z] is preferably obtained by reductive amination of a reduced sugar, such as glucose, fructose, maltose, lactose, galactose, mannose or xylose. The N-alkoxy- or N-aryloxy-substituted compounds can be converted to the desired polyhydroxyfatty acid amides by reaction with fatty acid methyl esters in the presence of an alkoxide as the catalyst.

Low-foaming nonionic surfactants are used as the preferred surfactants. It is particularly preferable for detergent or cleansing agents, especially cleansing agents for machine dishwashing, to contain nonionic surfactants from the group of alkoxylated alcohols. The nonionic surfactants used by preference are alkoxylated, advantageously ethoxylated, especially primary alcohols preferably having 8 to 18 C atoms and an average of 1 to 12 moles of ethylene oxide (EO) per mole of alcohol, in which the alcohol group can be linear or methyl-branched in the 2 position, or can contain a mixture of linear and methyl-branched groups, such as usually occur in oxoalcohol groups. In particular, though, alcohol ethoxylates with linear groups form alcohols of natural origin with 12 to 18 C atoms are preferred, such as those from coconut, palm, tallow or oleyl alcohol, and with an average of 2 to 8 moles of EO per mole of alcohol. Examples of the preferred ethoxylated alcohols include C₁₂₋₁₄-alcohols with 3 or 4 EO, C₉₋₁₁-alcohols with 7 EO, C₁₃₋₁₅-alcohols with 3 EO, 5 EO, 7 EO or 8 EO; C₁₂₋₁₈-alcohols with 3 EO, 5 EO or 7 EO and mixtures of them, such as mixtures of C₁₂₋₁₄-alcohol with 3 EO and C₁₂₋₁₈-alcohol with 5 EO. The degrees of ethoxylation stated are statistical averages, and can be integers or fractional numbers for a particular product. Preferred alcohol ethoxylates exhibit a narrower distribution of homologs (narrow range ethoxylates, NRE). In addition to these nonionic surfactants, fatty alcohols with more than 12 EO can also be used. Examples of those are tallow alcohols with 14 EO, 25 EO, 30 EO or 40 EO.

It is particularly preferable to use ethoxylated nonionic surfactants obtained from C₆₋₂₀-monohydroxyalkanols or C₆₋₂₀-alkylphenols or C₁₆₋₂₀-fatty alcohols and more than 12 moles, preferably more than 15 moles and particularly more than 20 moles of ethylene oxide per mole of alcohol. A particularly preferred nonionic surfactant is obtained from a straight-chain fatty alcohol with 16 to 20 carbon atoms (C₁₆₋₂₀-alcohol), preferably a C₁₈-alcohol and at least 12 moles, preferably at least 15 moles, and particularly at least 20 moles of ethylene oxide. Of these, the “narrow range ethoxylates” are especially preferred.

Other surfactants containing one or more tallow alcohols with 20 to 30 EO in combination with a silicone antifoam are used to special advantage.

Nonionic surfactants having melting points above room temperature are particularly preferred. Nonionic surfactant(s) having a melting point above 20° C., preferably above 25° C., especially preferably between 25 and 60° C., and particularly, between 26.6 and 43.3° C. is/are especially preferred.

Suitable nonionic surfactants having melting or softening points in the specified temperature ranges are, for instance, low-foaming nonionic surfactants which may be solid or highly viscous at room temperature. If nonionic surfactants that are highly viscous at room temperature are used, it is preferred that they have a viscosity greater than 20 Pa-s, preferably above 35 Pa-s, and especially above 40 Pa-s. Nonionic surfactants having a waxy consistency at room temperature are also preferred.

Nonionic surfactants from the group of alkoxylated alcohols, especially preferably from the group of mixed alkoxylated alcohols, and particularly from the group of EO-AO-EO nonionic surfactants are likewise used to special advantage.

The nonionic surfactant that is solid at room temperature preferably has propylene oxide units in the molecule. Preferably such PO units make up as much as 25% by weight of the total molecular weight of the nonionic surfactant, especially preferably up to 20% by weight, and particularly up to 15% by weight. Especially preferred nonionic surfactants are ethoxylated monohydroxyalkanols or alkylphenols which also have polyoxyethylene-polyoxypropylene block copolymer units. The alcohol or alkylphenol portion of such nonionic surfactant molecules preferably makes up more than 30% by weight, especially preferably more than 50% by weight, and particularly more than 70% by weight of the total molecular weight of such nonionic surfactants. Preferred agents are characterized by containing ethoxylated and propoxylated nonionic surfactants in which the propylene oxide units in the molecule amount to up to 25% by weight, preferably up to 20% by weight, and particularly up to 15% by weight of the total molecular weight of the nonionic surfactant.

Surfactants used preferably are derived from the groups of alkoxylated nonionic surfactants, especially the ethoxylated primary alcohols and mixtures of those surfactants with more structurally complex surfactants such as polyoxypropylene/polyoxyethylene/polyoxypropylene ((PO/EO/PO) surfactants). Such (PO/EO/PO) surfactants are further distinguished by good foam control.

Other preferably used nonionic surfactants with melting points above room temperature contain 40% to 70% of a polyoxypropylene/polyoxyethylene/polyoxypropylene block polymer blend containing 75% by weight of an inverse block copolymer of polyoxyethylene and polyoxypropylene having 17 moles of ethylene oxide and 44 moles of propylene oxide, and 25% by weight of a block copolymer of polyoxyethylene and polyoxypropylene, initiated with trimethylolpropane and containing 24 moles of ethylene oxide and 99 moles of propylene oxide per mole of trimethylolpropane.

In the context of the present invention, low-foaming nonionic surfactant having alternating ethylene oxide and propylene oxide units have proven to be particularly preferred nonionic surfactants. Of these, again, surfactants with EO-AO-EO-AO blocks are preferred, in which one to ten EO or AO groups are bonded together before being followed by a block of the other groups. Here, nonionic surfactants of the general formula

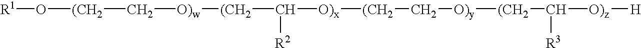

in which R¹ stands for a straight or branched, saturated or singly or multiply unsaturated C₆₋₂₄-alkyl or -alkenyl group. Each R² or R³ group is selected, independently of each other, from —CH₃, —CH₂CH₃, —CH₂CH₂—CH₃, or CH(CH₃)₂, and the indices w, x, y, and z, independently of each other, stand for integers from 1 to 6.

The preferred nonionic surfactants of the formula above can be produced by known methods from the corresponding alcohols, R¹—OH and ethylene oxide or alkylene oxide. The R¹ group in the formula above can vary, depending on the origin of the alcohol. If natural sources are used, the R¹ group has an even number of carbon atoms and is, as a rule, unbranched, with the linear groups of alcohols of natural origin preferably having 12 to 18 C atoms, e.g., coconut, palm, tallow or oleyl alcohol. Alcohols accessible from synthetic sources are, for instance, the Guerbet alcohols or groups methyl-branched in the 2 position, or mixed linear and methyl-branched groups, such as usually occur in oxoalcohol groups. Independently of the manner of production of the alcohols used in the nonionic surfactants, those nonionic surfactants are preferred in which the R¹ in the formula above represents an alkyl group with 6 to 24, preferably 8 to 20, especially preferably 9 to 15, and particularly 9 to 11 carbon atoms.

Aside from propylene oxide, butylene oxide, in particular, can be considered as an alkylene oxide unit alternating with the ethylene oxide unit in the preferred nonionic surfactants. However, other alkylene oxides in which R² or R³ are selected, independently of each other, from —CH₂CH₂—CH₃ or CH(CH₃)₂ are also suitable. Nonionic surfactants of the formula above in which R² or R³ stands for a —CH₃ group, w and x, independently of each other, stand for values of 3 or 4, and y and z, independently of each other, stand for values of 1 or 2, are preferred.

In summary, those nonionic surfactants are particularly preferred which have a C₉₋₁₅-alkyl group with 1 to 4 ethylene oxide units, followed by 1 to 5 propylene oxide units, followed by 1 to 4 ethylene oxide units, followed by 1 to 4 propylene oxide units. These surfactants exhibit the required low viscosity in aqueous solution and are usable to special advantage according to the invention.

Surfactants of the general formula

R¹—CH(OH)CH₂O-(AO)_{w}-(A′O)ₓ-(A″O)_{y}-(A′″O)_{z}—R²

in which R¹ and R², independently of each other, stand for a straight or branched, saturated or singly or multiply unsaturated C₂₋₄₀-alkyl or -alkenyl group; A, A′, A″ and A′″, independently of each other, stand for a group from the set —CH₂CH₃, —CH₂CH₂—CH₂, —CH₂—CH(CH₃), —CH₂—CH₂—CH₂—CH₂, —CH₂—CH(CH₃)—CH₂—, or —CH₂—CH(CH₂—CH₃); and w, x, y, and z stand for values between 0.5 and 90, where x, y, and/or z can also be 0, are preferred according to the invention.

In particular, those end-capped poly(alkoxylated) nonionic surfactants are preferred which, according to the formula

R¹O[CH₂CH₂O]ₓCH₂CH(OH)R²

have, aside from the group R¹, which stands for a linear or branched, saturated or unsaturated, aliphatic or aromatic hydrocarbon group with 2 to 30 C atoms, preferably with 4 to 22 carbon atoms, have also a linear or branched, saturated or unsaturated, aliphatic or aromatic hydrocarbon group R² with 1 to 30 carbon atoms, in which x stands for values between 1 and 90, preferably for values between 40 and 80, and especially for values between 40 and 60.

### Surfactants of the Formula

R¹O[CH₂CH(CH₃)O]ₓ[CH₂CH₂O]_{y}CH₂CH(OH)R²,

in which R¹ stands for a linear or branched aliphatic hydrocarbon group with 4 to 18 carbon atoms or mixtures of them, R² stands for a linear or branched hydrocarbon group with 2 to 26 carbon atoms or mixtures of them, and x stands for values between 0.5 and 1.5, and y stands for a value of at least 15 are especially preferred.

Those end-capped poly(alkoxylated) nonionic surfactant of the formula

R¹O[CH₂CH₂O]ₓ[CH₂CH(R³)O]_{y}CH₂CH(OH)R²,

in which the R¹ and R², independently of each other, stand for a linear or branched, saturated or singly or multiply unsaturated hydrocarbon group with 2 to 26 carbon atoms, R³ is selected independently of each other, from —CH₃, —CH₂CH₃, —CH₂CH₂—CH₃, or —CH(CH₃)₂, but preferably stands for —CH₃; and x and y, independently of each other, stand for values between 1 and 32 are especially preferred. Nonionic surfactants in which R³ is —CH₃, values of x are from 15 to 32, and values of y are from 0.5 to 1.5 are quite particularly preferred.

Other preferably usable nonionic surfactants are the end-capped poly(alkoxylated) nonionic surfactants of the formula

R¹O[CH₂CH(R³)O]ₓ[CH₂]ₖCH(OH)[CH₂]OR²,

in which R¹ and R² stand for linear or branched, saturated or unsaturated, aliphatic or aromatic hydrocarbon groups with 1 to 30 carbon atoms; R³ stands for H or for a methyl, ethyl, n-propyl, isopropyl, n-butyl, 2-butyl, or 2-methyl-2-butyl group; x stands for a value between 1 and 30; and k and j stand for values between 1 and 12, preferably between 1 and 5. If the value x is ≧2, each R³ in the preceding formula

R¹O[CH₂CH(R³)O]ₓ[CH₂]ₖCH(OH)[CH₂]OR²,

can be different. R¹ and R² are preferably linear or branched, saturated or unsaturated, aliphatic or aromatic hydrocarbon groups with 6 to 22 carbon atoms, and groups with 8 to 12 C atoms are especially preferred. H, —CH₃, or —CH₂CH₃ are especially preferred for the group R³. Especially preferred values for x are in the range of 1 to 20, particularly 6 to 15.

As described above, each R³ in the preceding formula can be different if x≧2. Thus the alkylene oxide unit in the square brackets can be varied. For instance, if x stands for 3, ethylene oxide (R³=H) or propylene oxide units (R=—CH₃) can be selected to make up the group R³. They can follow each other in any sequence, such as (EO)(PO)(EO), (EO)(EO)(PO), (EO)(EO)(EO), (PO)(EO)(PO), (PO)(PO)(EO), and (PO)(PO)(PO). Although the value of 3 is chosen for x here as an example, it can be greater. The range of variation increases with increasing values of x, including, for instance, a large number of (EO) groups combined with a small number of (PO) groups, or conversely.

Particularly preferred end-capped poly(alkoxylated) alcohols of the preceding formula have values of k=1 and j=1, so that the preceding formula simplifies to

R¹O[CH₂CH(R³)O]ₓCH₂CH(OH)CH₂OR²,

In the latter formula, R¹, R², and R³ are defined as above, and x stands for numbers from 1 to 30, preferably 1 to 20 and especially 6 to 18. Surfactants in which the groups R¹ and R² have 9 to 14 C atoms, R³ stands for H, and x takes on values of 6 to 15 are especially preferred.

The carbon-chain lengths stated, and the degrees of ethoxylation or alkoxylation for the aforementioned nonionic surfactants are statistical averages which can be integers or fractional numbers for a specific product. Because of the manufacturing processes, commercial products of the given formulas usually do not consist of individual representatives but of mixtures which yield averages and thus the following fractional numbers for the carbon-chain lengths as well as for the degree of ethoxylation or alkoxylation.

Obviously, the aforementioned nonionic surfactants need not be used as single substances, but as surfactant mixtures of two, three, four or more surfactants. Here the term “surfactant mixtures” does not mean mixtures of nonionic surfactants, all of which are described by one of the general formulas presented above, but instead mixtures containing two, three, four or more nonionic surfactants that can be described by various of the general formulas presented.

If the anionic surfactants are ingredients of a machine dishwashing agent, then their concentration, based on the total weight of the agent, is preferably less than 4% by weight, preferably less than 2% by weight, and quite particularly preferably less than 1% by weight. Machine dishwashing agents that do not contain any anionic surfactants are especially preferred.

Cationic and/or amphoteric surfactants can also be used in place of or in combination with the surfactants mentioned.

For example, cationic compounds of the following formulas can be used as cationic active substances:

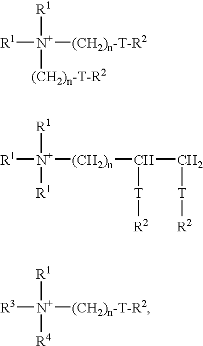

in which each R¹ group is selected, independently of each other, from C₁₋₅-alkyl, -alkenyl, or -hydroxyalkyl groups; each R² group is selected, independently of each other, from C₈₋₂₈-alkyl or -alkenyl groups; R³=R¹ or R² or (CH₂)ₙ-T-R², where T=—CH₂—, —O—CO— or —CO—O—, and n is an integer from 0 to 5.

In machine dishwashing agents, the concentration of cationic and/or amphoteric surfactants is preferably less than 6% by weight, preferably less than 4% by weight, quite specially preferably less than 2% by weight, and, in particular, less than 1% by weight. Machine dishwashing agents which do not contain any cationic or amphoteric surfactants are especially preferred.

The group of polymers includes, in particular, the polymers active as detergents or cleansers, such as the wetting agents and/or the polymers that are active as water softeners. In general, cationic, anionic and amphoteric polymers can be used along with nonionic polymers in detergent or cleansing agents.

“Cationic polymers” in the sense of the present invention are polymers bearing a positive charge in the polymer molecule. That can be provided, for example, by (alkyl)ammonium groups or other positively charged groups in the polymer chain. Particularly preferred cationic polymers are derived from the groups of quaternized cellulose derivatives, polysiloxanes with quaternary groups, the cationic guar derivatives, the polymeric dimethyldiallylammonium salts and their copolymers with esters and amides of acrylic acid and methacrylic acid, the copolymers of vinylpyrrolidone with quaternized derivatives of dialkylaminoacrylates and dialkylaminomethacrylates, the vinylpyrrolidone-methoimidazolinium chloride copolymers, the quaternized polyvinyl alcohols, or the polymers listed under the INCI designations Polyquaternium 2, Polyquaternium 17, Polyquaternium 18 and Polyquaternium 27.

“Amphoteric polymers” in the sense of the present invention bear, along with a positively charged group in the polymer chain, also negatively charged groups or monomer units. These groups can, for instance, be carboxylic acids, sulfonic acids or phosphonic acids.

Preferred detergent or cleansing agents, especially preferred machine dishwashing agents, are distinguished by containing a polymer a) having monomer units of the formula R¹R²C═CR³R⁴ in which each group R¹, R², R³ and R⁴ is selected independently of each other from hydrogen, derivatized hydroxyl groups, linear or branched C₁₋₃₀-alkyl groups, aryl, linear or branched aryl-substituted C₁₋₃₀-alkyl groups, polyalkoxylated alkyl groups, organic heteroatomic groups with at least one positive charge without a charged nitrogen, at least one quaternized N atom or at least one amino group with a positive charge in the sub-region of the pH range from 2 to 11, or salts of them, with the specification that at least one group R¹, R², R³, or R⁴ is an organic heteroatomic groups with at least one positive charge without a charged nitrogen, at least one quaternized N atom or at least one amino group with a positive charge.

In the context of the present invention, specially preferred cationic or amphoteric polymers contain, as a monomer unit, a compound of the general formula

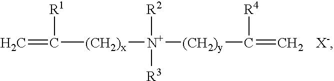

in which the R¹ and R⁴, independently of each other, stand for H or for a linear or branched hydrocarbon group with 1 to 6 carbon atoms; R² and R³ independently of each other stand for an alkyl, hydroxyalkyl or aminoalkyl group in which the alkyl group is linear or branched and has between 1 and 6 carbon atoms, being preferably a methyl group; and x and y, independently of each other stand for integers between 1 and 3.
X⁻ represents a counterion, preferably a counterion from the group chloride, bromide, iodide, sulfate, bisulfate, methosulfate, laurylsulfate, dodeclbenzenesulfonate, p-toluenesulfonate (tosylate), cumenesulfonate, xylenesfulfonate, phosphate, citrate, formate, acetate, or mixtures of those.

It is preferable for the groups R¹ and R⁴ in the preceding formula to be selected from —CH₃, —CH₂CH₃, —CH₂CH₂—CH₃, —CH(CH₃)CH₂, —CH₂OH, —CH₂CH₂OH, —CHOH—CH₃, —CH₂—CH₂—CH₂—OH, —CH₂—CHOH—CH₃, —CHOH—CH₂—CH₃ and —(CH₂CH₂—O)ₙH.

Polymers having a cationic monomer unit of the general formula above in which R¹ and R⁴ stand for H, R² and R³ stand for methyl, and x and y are both 1 are quite specially preferred. The corresponding monomer units of the formula

H₂C═CH—(CH₂)—N⁺(CH₃)₂—(CH₂)—CH═CH₂

X⁻

are also known as DADMAC (diallyldimethylammonium chloride) of X⁻ is chloride.

Other specially preferred cationic or amphoteric polymers contain a monomer unit of the general formula

R¹HC═CR²—C(O)—NH—(CH₂)ₓ—N⁺R³R⁴R⁵

X⁻,

in which R¹, R², R³, and R⁴, independently of each other, stand for a linear or branched, saturated or unsaturated alkyl or hydroxyalkyl group with 1 to 6 carbon atoms, preferably for a linear or branched alkyl group selected from —CH₃, —CH₂CH₃, —CH₂CH₂—CH₃, —CH(CH₃)CH₂, —CH₂OH, —CH₂CH₂OH, —CHOH—CH₃, —CH₂—CH₂—CH₂—OH, —CH₂—CHOH—CH₃, —CHOH—CH₂—CH₃ and —(CH₂CH₂—O)ₙH and x stands for an integer between 1 and 6.

In the context of the present invention, those polymers are quite specially preferred which have a cationic monomer unit of the general formula above, and in which R¹ stands for H and R², R³, R⁴ and R⁵ stand for methyl and x stands for 3. The corresponding monomer units of the formula

H₂C═C(CH₂)—C(O)—NH—(CH₂)ₓ—N⁺(CH₃)₃

X⁻

are called MAPTAC (methacylamidopropyl-trimethylammonium chloride) if X⁻ is chloride.

Those polymers are used preferably according to the invention which contain as monomer units diallyldimethylammonium salts and/or acrylamidopropyltrimethylammonium salts.

The amphoteric polymers previously mentioned do not only have cationic groups, but also anionic groups or monomer units. Such anionic monomer units are derived, for example, from the group of linear or branched, saturated or unsaturated carboxylates, the linear or branched, saturated or unsaturated phosphonates, the linear or branched, saturated or unsaturated sulfates or the linear or branched, saturated or unsaturated, sulfonates. Preferred monomer groups are acrylic acid, methacrylic acid, dimethylacrylic acid, ethylacrylic acid, cyanoacrylic acid, vinylacetic acid, allylacetic acid, crotonic acid, maleic acid, fumaric acid, cinnamic acid, and their derivatives, the allylsulfonic acids, such as allyloxybenzenesulfonic acid, and methallylsulfonic acid or the allylphosphonic acids.

Preferred usable amphoteric polymers are derived from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkylmethacrylic acid copolymers, the alkylacrylamide/methylmethacrylic acid/alkylaminoethylmethacrylate/alkylmethacrylate copolymers and the copolymers of unsaturated carboxylic acids, cationically derivatized unsaturated carboxylic acids and optionally other ionic or nonionic monomers.

Preferred usable zwitterionic polymers are derived from the group of acrylamidoalkyltrialkylammonium chloride/acrylic acid copolymers and their alkali and ammonium salts, the acrylamidoalkyltrialkylammonium chloride/methacrylic acid copolymers and their alkali and ammonium salts, and the methacroylethylbetaine/methacrylate copolymers.

Amphoteric polymers which contain methacrylamidoalkyl-trialkylammonium chloride and dimethyldiallylammonium chloride as cationic monomers, with one or more anionic monomers, are also preferred.

Specially preferred amphoteric polymers are derived from the group of methacrylamidoalkyl-trialkylammonium chloride/dimethyldiallylammonium chloride/methacrylic acid copolymers, the methacrylamidoalkyltrialkylammonium chloride/dimethyldiallylammonium chloride/methacrylic acid copolymers and the methacrylamidoalkyltrialkylammonium chloride/dimethyldiallylammonium chloride/alkylmethacrylic acid copolymers and their alkali and ammonium salts.

Amphoteric polymers from the group of methacrylamidopropyltrimethylammonium chloride/dimethyldiallylammonium chloride/acrylic acid copolymers, the methacrylamidopropyltrimethylammonium chloride/dimethyldiallylammonium chloride/acrylic acid copolymers and the methacrylamidopropyltrimethylammonium chloride dimethyldiallylammonium chloride/alkylmethacrylic acid copolymers and their alkali and ammonium salts are especially preferred.

In a specially preferred embodiment of the present invention, the polymers are present in preprocessed form. Suitable means of processing the polymers include, among others:
encapsulation of the polymers by means of a water-soluble or water-dispersible coating means, preferably by means of water-soluble or water-dispersible natural or synthetic polymers;
encapsulation of the polymers by means of water-insoluble fusible coating means, preferably by means of water-insoluble coating agents from the groups of waxes or paraffins having melting points above 30° C.
co-granulation of the polymers with inert carrier materials, preferably with carrier materials from the group of substances with detergent or cleansing action, especially preferably from the group of builders or cobuilders.

Detergents or cleansers contain the aforementioned cationic and/or amphoteric polymers preferably in proportions of 0.01 to 10% by weight, based on the total weight of the detergent or cleanser. However, in the context of the present invention, those detergents or cleansers are preferred for which the proportion by weight of the cationic and/or amphoteric polymers is between 0.01 and 8% by weight, preferably between 0.01 and 6% by weight, preferably between 0.01 and 4% by weight, especially preferably between 0.01 and 2% by weight, and particularly between 0.01 and 1% by weight, based in each case on the total weight of the machine dishwashing agent.

The polymers that contain sulfonic acid groups are examples of polymers effective as water softeners. They are used to special advantage.

Copolymers of unsaturated carboxylic acids, monomers containing sulfonic acid groups, and optionally other ionogenic or nonionogenic monomers are specially preferred for use as polymers containing sulfonic acid groups.

In the context of the present invention, preferred monomers are unsaturated carboxylic acids of the formula

R¹(R²)C═C(R³)COOH

in which the R¹ to R³, independently of each other, stand for H, —CH₃, a straight or branched alkyl group with 2 to 12 carbon atoms, a straight or branched, singly or multiply unsaturated alkenyl group with 2 to 12 carbon atoms, an alkyl or alkenyl group substituted with NH₂, —OH, or —COOH, or for COOH or COOR⁴, where R⁴ is a saturated or unsaturated, straight or branched hydrocarbon group with 1 to 12 carbon atoms.

Of the unsaturated carboxylic acids that can be described by the preceding formula, acrylic acid (R¹=R²=R³=H), methacrylic acid (R¹=R²=H; R³=—CH₃) and/or maleic acid (R¹=COOH; R²=R³=H) are particularly preferred.

Of the monomers containing sulfonic acid groups, those are preferred that have the formula

R⁶(R⁵)C═C(R⁷)—X—SO₃H

in which R⁵ to R⁷, independently of each other, stand for —H, —CH₃, a straight or branched saturated alkyl group with 2 to 12 carbon atoms, a straight or branched singly or multiply unsaturated alkenyl group with 2 to 12 carbon atoms, or an alkyl or alkenyl group substituted with —NH₂, —OH, or —COOH, or for —COOH or —COOR⁴, in which R⁴ is a saturated or unsaturated, straight or branched hydrocarbon group with 1 to 12 carbon atoms and X stands for an optionally present spacer group that is selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Of these monomers, the ones with the formulas

H₂C═CH—X—SO₃H

H₂C═C(CH₃)—X—SO₃H

HO₃S—X—(R⁶)C═C(R⁷)—X—SO₃H

in which R⁶ and R⁷ are selected, independently of each other, from —H, —CH₃, —CH₂CH₃, —CH₂CH₂—CH₃, and —CH(CH₃)₂, and X stands for an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)— are specially preferred.

Specially preferred monomers containing sulfonic acid groups are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethyl methacrylamide and water-soluble salts of the acids named.

Other ionogenic or nonionogenic monomers that can be considered include, in particular, ethylenically unsaturated compounds. The concentration of these other ionogenic or nonionogenic monomers in the polymers used is preferably less than 20% by weight, based on the polymer. Polymers used especially preferably consist solely of monomers of the formula R¹(R²)C═(R³)COOH and monomers of the formula

R⁵(R⁶)C═C(R⁷)—X—SO₃H.

Other specially preferred copolymers comprise
i) one or more unsaturated carboxylic acids from the group of acrylic acid, methacrylic acid and/or maleic acid
ii) one or more monomers containing sulfonic acid groups, having the formulas:

H₂C═CH—X—SO₃H

H₂C═C(CH₃)—X—SO₃H

HO₃S—X—(R⁶)C═C(R⁷)—X—SO₃H

in which R⁶ and R⁷ are selected, independently of each other, from —H, —CH₃, —CH₂CH₃, —CH₂CH₂—CH₃, and —CH(CH₃)₂, and X stands for an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optionally, other ionogenic or nonionogenic monomers.

The copolymers can contain the monomers of groups i) and ii), and optionally iii) in varying proportions, whereby all the representatives of group i) can be combined with all the representatives of group ii) and all the representatives of group iii). Specially preferred polymers have certain structural units described in the following.

Thus, for instance, copolymers are preferred that contain structural units of the formula

—[CH₂—CHCOOH]ₘ—[CH₂—CHC(O)—Y—SO₃H]ₚ—

in which m and p each stand for a natural integer between 1 and 2,000 and Y stands for a spacer group selected from substituted or unsubstituted aliphatic, aromatic or substituted aromatic hydrocarbon groups with 1 to 24 carbon atoms, in which spacer groups are preferred in which Y stands for —O—(CH₂)ₙ—, with n=0 to 4, for —O—(C₆H₄)—, for —NH—C(CH₃)₂— or for —NH—CH(CH₂CH₃)—.

These polymers are produced by copolymerization of acrylic acid with an acrylic acid derivative containing sulfonic acid groups. If one copolymerizes the acrylic acid derivative containing sulfonic acid groups with methacrylic acid, one gets a different polymer, the use of which is likewise preferred. The corresponding polymers contain structural units of the formula

—[CH₂—C(CH₃)COOH]ₘ—[CH₂—CHC(O)—Y—SO₃H]ₚ—

in which m and p each stands for a natural integral between 1 and 2,000, and Y stands for a spacer group selected from substituted or unsubstituted aliphatic, aromatic or substituted aromatic hydrocarbon groups with 1 to 24 carbon atoms, in which spacer groups are preferred in which Y stands for —O—(CH₂)ₙ—, with n=0 to 4, for —O—(C₆H₄)—, for —NH—C(CH₃)₂— or for —NH—CH(CH₂CH₃)—.

Entirely analogously, acrylic acid and/or methacrylic acid can also be copolymerized with methacrylic acid derivatives containing sulfonic acid groups, so that the structural unit in the molecules are altered. In this way, copolymers containing structural units of the formula

—[CH₂—CHCOOH]ₘ—[CH₂—C(CH₃)C(O)—Y—SO₃H]ₚ—

are obtained, in which m and p each stands for a natural integer between 1 and 2,000, and Y stands for a spacer group selected from substituted or unsubstituted aliphatic, aromatic or substituted aromatic hydrocarbon groups with 1 to 24 carbon atoms, in which spacer groups are preferred in which Y stands for —O—(CH₂)ₙ—, with n=0 to 4, for —O—(C₆H₄)—, for —NH—C(CH₃)₂— or for —NH—CH(CH₂CH₃)—. They are preferred just as are copolymers containing structural units of the formula

—[CH₂—C(CH₃)COOH]ₘ—[CH₂—C(CH₃)C(O)—Y—SO₃H]ₚ—

in which m and p each stands for a natural integer between 1 and 2,000, and Y stands for a spacer group selected from substituted or unsubstituted aliphatic, aromatic or substituted aromatic hydrocarbon groups with 1 to 24 carbon atoms, in which spacer groups are preferred in which Y stands for —O—(CH₂)ₙ—, with n=0 to 4, for —O—(C₆H₄)—, for —NH—C(CH₃)₂— or for —NH—CH(CH₂CH₃)—.

Instead of or in addition to acrylic acid and/or methacrylic acid, maleic acid can also be used as a specially preferred monomer from group i). In this way, one arrives at copolymers preferred according to the invention which contain structural units of the formula

—[HOOCCH—CHCOOH]ₘ—[CH₂—CHC(O)—Y—SO₃H]ₚ—

in which m and p each stands for a natural integer between 1 and 2000, and Y stands for a spacer group selected from substituted or unsubstituted aliphatic, aromatic or arylaliphatic hydrocarbon groups with 1 to 24 carbon atoms, in which spacer groups are preferred in which Y stands for —O—(CH₂)ₙ—, with n=0 to 4, for —O—(C₆H₄)—, for —NH—C(CH₃)₂— or for —NH—CH(CH₂CH₃)—. Other preferred copolymers contain structural units of the formula

—[HOOCCH—CHCOOH]ₘ—[CH₂—C(CH₃)C(O)O—Y—SO₃H]ₚ—

in which m and p each stands for a natural integer between 1 and 2000, and Y stands for a spacer group selected from substituted or unsubstituted aliphatic, aromatic or substituted aromatic hydrocarbon groups with 1 to 24 carbon atoms, in which spacer groups are preferred in which Y stands for —O—(CH₂)ₙ—, with n=0 to 4, for —O—(C₆H₄)—, for —NH—C(CH₃)₂— or for —NH—CH(CH₂CH₃)—.

The sulfonic acid groups in the polymers can be in partially or completely neutralized form. That is, the acidic hydrogen atom of the sulfonic acid group can be replaced, in some or all of the sulfonic acid groups, by metal ions, preferably alkali metal ions and particularly by sodium ions. Use of copolymers containing partially or completely neutralized sulfonic acid groups is preferred according to the invention.

For copolymers that contain only monomers of groups i) and ii), the monomeric distribution of the copolymers preferably used according to the invention is preferably 5 to 95% by weight i) or ii), especially preferably 50 to 90% by weight monomers of group i) and 10 to 50% by weight monomers of group ii), based on the polymer in each case.

The preferred terpolymers are those that contain 20 to 85% by weight of monomer from group i), 10 to 60% by weight monomer from group ii), and 5 to 30% by weight monomer from group iii).

The molecular weights of the sulfo-copolymers preferred for use according to the invention can be varied to adapt the properties of the polymers to the desired application. Preferred detergent or cleansing agents are distinguished by the copolymers having molecular weights of 2,000 to 200,000 g/mole, preferably 4,000 to 25,000 g/mole, and especially 5,000 to 15,000 g/mole.

Bleaches are substances with detergent or cleansing action that are used to particular advantage. Among the compounds that act as bleaches, providing H₂O₂ in water, sodium percarbonate, sodium perborate tetrahydrate, and sodium perborate monohydrate are particularly important. Examples of other usable bleaching agents include peroxypyrophosphate, citrate perhydrate, and peracids or salts of peracids that produce H₂O₂, such as perbenzoate, peroxophthalate, diperazalaic acid, phthaloimino peracid or diperdodecanoic diacid.

Bleaches from the group of organic bleaching agents can also be used. Typical organic bleaching agents are the diacyl peroxides, such as dibenzoyl peroxide. The peroxy acids are other typical organic bleaching agents, and the alkyl peroxy acids and aryl peroxy acids must be mentioned as particular examples. Preferred representatives that can also be used are:
(a) the peroxybenzoic acids and their ring-substituted derivatives, such as alkylperoxybenzoic acids, as well as peroxy-α-naphthoic acid and magnesium monoperphthalate;
(b) the aliphatic or substituted aliphatic peroxy acids such as peroxylauric acid, peroxystearic acid, ε-phthalimidoperoxycaproic acid [phthaliminoperoxyhexanoic acid, (PAP)], o-carboxybenzamidoperoxycaproic acid, N-nonenylamidoperadipic acid and N-nonenylamidopersuccinate; and
(c) aliphatic and aryl-aliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyl-diperoxy-1,4-butane-dicarboxylic acid, and N,N-terephthaloyl-di(6-aminopercaproic acid).

Substances that release chlorine or bromine can also be used as bleaching agents. Suitable materials that release chlorine or bromine include, as examples, N-bromo amides and N-chloroamides, such as trichloroisocyanuric acid, tribromoisocyanuric acid, dibromoisocyanuric acid and/or dichloroisocyanuric acid (DICA) and/or their salts with cations such as potassium and sodium. Hydantoin compounds such as 1,3-dichloro-5,5-dimethylhydantoin, are also suitable.

Detergents or cleansers that contain 1 to 35% by weight, preferably 2.5 to 30% by weight, especially preferably 3.5 to 20% by weight, and particularly 5 to 15% by weight bleaching agent, preferably sodium percarbonate, are preferred according to the invention.

It is preferred that the active oxygen content of the detergent or cleanser, especially the machine dishwashing compound, be between 0.4 and 10% by weight, especially preferably between 0.5 and 8% by weight, and particularly between 0.6 and 5% by weight, based in each case on the total weight of the compound. Specially preferred agents have an active oxygen content above 0.3% by weight, preferably above 0.7% by weight, especially preferably above 0.8% by weight, and particularly above 1.0% by weight.

Bleach activators are used in detergents or cleansers, for example, to achieve improved bleaching action at temperatures of 60° C. and below. Compounds that, under perhydrolysis conditions, yield aliphatic peroxocarboxylic acids with preferably 1 to 10 C atoms, especially 2 to 4 C atoms and/or optionally substituted perbenzoic acid can be used. Substances that bear O-acyl and/or N-acyl groups of the specified number of C atoms and/or optionally substituted benzoyl groups are suitable. Multiply acylated alkylenediamines are suitable, especially tetraacetylethylenediamine (TAED), acylated triazine derivatives, particularly 1,5-diacetyl-2,4-dioxohexahydro-1,3,5-triazine (DAD HT), acylated glycolurils, particularly tetraacetylglycoluril (TAGU), N-acylimides, particularly N-nonanoylsuccinimide (NOSI), acylated phenolsulfonates, particularly n-nonanoyl- or isononanoyl oxybenzenesulfonate (n- or iso-NOBS), carboxylic acid anhydrides, particularly phthalic anhydride, acylated multifunctional alcohols, particularly triacetin, ethylene glycol diacetate and 2,5-diacetoxy-2,5-dihydrofuran.

Other bleaching agents preferred for use in the context of the present invention are compounds of the group of cationic nitriles, especially cationic nitriles of the formula

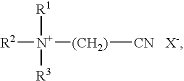

in which R¹ stands for —H, —CH₃; a C₂₋₂₄-alkyl or -alkenyl group; a substituted C₂₋₂₄-alkyl or -alkenyl group having at least one substituent from the group —Cl, —Br, —OH, —NH₂, or —CN; an alkyl or alkenylaryl group with a C₁₋₂₄-alkyl group; or for a substituted alkyl or alkenylaryl group having a C₁₋₂₄-alkyl group and at least one other substituent on the aromatic ring; R² and R³ are selected independently of each other from —CH₂—CN, —CH₃, —CH₂CH₃, —CH₂CH₂—CH₃, —CH(CH₃)—CH₃, —CH₂OH, —CH₂CH₂OH, —CHOH—CH₃, —CH₂—CH₂—CH₂—OH, —CH₂—CHOH—CH₃, —CHOH—CH₂CH₃ or —(CH₂CH₂O)ₙH with n=1, 2, 3, 4, 5, or 6; and X is an anion, preferably from the group of chloride, bromide, iodide, bisulfate, methosulfate, p-toluenesulfonate (tosylate) or xylenesulfonate.

Especially preferred compounds are those of the formulas (CH₃)₃N⁽⁺⁾CH₂—CNX⁻, (CH₃CH₂)₃N⁽⁺⁾CH₂—CNX⁻, (CH₃CH₂CH₂)₃N⁽⁺⁾CH₂—CNX⁻, (CH₃CH(CH₃))₃N⁽⁺⁾CH₂—CNX⁻, or (HO—CH₂CH₂)₃N⁽⁺⁾CH₂—CNX⁻. Of this group of substances, the cationic nitrile of the formula (CH₃)₃N⁽⁺⁾CH₂—CNX⁻, in which X⁻ stands for an anion selected from the group of chloride, bromide, iodide, bisulfate, methosulfate, p-toluenesulfonate (tosylate) or xylensulfonate is particularly preferred.

Compounds that under perhydrolysis conditions yield aliphatic peroxocarboxylic acids with preferably 1 to 10 C atoms, especially 2 to 4 C atoms, and/or optionally substituted perbenzoic acid can also be used as bleach activators. Substances bearing O-acyl and/or N-acyl groups of the specified number of C atoms and/or optionally substituted benzoyl groups are suitable. Multiply acylated alkylenediamines, especially tetraacetyl-ethylenediamine (TAED) are preferred, acylated triazine derivatives, particularly 1,5-diacetyl-2,4-dioxohexahydro-1,3,5-triazine (DAD HT), acylated glycolurils, particularly tetraacetylglycoluril (TAGU), N-acylimides, particularly N-nonanoylsuccinimide (NOSI), acylated phenolsulfonates, particularly n-nonanoyl- or isononanoyl oxybenzenesulfonate (n- or iso-NOBS), carboxylic acid anhydrides, particularly phthalic anhydride, acylated multifunctional alcohols, particularly triacetin, ethylene glycol diacetate, 2,5-diacetoxy-2,5-dihydrofuran, n-methylmorpholinium-acetonitrile-methyl sulfate (MMA) and acetylated sorbitol and mannitol or their mixtures (SORMAN), acylated sugar derivatives, especially pentaacetylglucose (PAG), pentaacetylfructose, tetraacetylxylose and octaacetyllactose as well as acetylated, optionally N-alkylated glucamine and gluconolactone, and/or N-acylated lactams, such as N-benzoylcapro-lactam. Hydrophilically substituted acylacetals and acyllactams are likewise used preferably. Combinations of conventional bleach activators can also be used.

To the extent that other bleach activators than the nitrile quats are to be used, it is preferable to use bleach activators from the group of multiply acylated alkylenediamines, especially tetraacetylethylenediamine (TAED), N-acylimides, especially N-nonanoylsuccinimide (NOSI), acylated phenolsulfonates, especially n-nonanoyl- or isononanoyl-oxybenzenesulfonate (n- or iso-NOBS), n-methylmorpholinium-acetonitrile-methyl sulfate (MMA), preferably in proportions of up to 10% by weight, particularly 0.1% by weight to 8% by weight, especially 2 to 8% by weight, and especially preferably 2 to 6% by weight, based in each case on the agent containing the bleach activator.

Bleach catalysts can also be used in place of or in addition to the conventional bleach activators. These substances are bleach-intensifying transition metal salts or transition metal complexes such as Mn, Fe, Co, Ru or Mo salen complexes or carbonyl complexes. Mn, Fe, Co, Ru, Mo, Ti, V and Cu complexes with nitrogen-containing tripod ligands and Co, Fe, Cu and Ru amine complexes are also usable as bleach catalysts.

Bleach-intensifying transition metal complexes, especially having a central atom of Mn, Fe, Co, Cu, Mo, V, Ti and/or Ru, preferably selected from the group of manganese and/or cobalt salts and/or complexes, especially preferably from the cobalt (amine) complexes, the cobalt (acetate) complexes, the cobalt (carbonyl) complexes, or the chlorides of cobalt or manganese or manganese sulfate are used in the usual proportions, preferably in a proportion of up to 5% by weight, especially from 0.0025 to 1% by weight and especially preferably from 0.01% by weight up to 0.25% by weight, based in each case on the total weight of the means containing the bleach activator. However, in special cases, even more bleach activator can be used.

Enzymes can be used to increase the cleansing power, or the detergent power, of detergents or cleansers. Those include in particular proteases, amylases, lipases, hemicellulases, cellulases or oxidoreductases, and, preferably, mixtures of them. These enzymes are in principle of natural origin. Variants improved over the natural molecules, which are used preferably, are available for use in detergents and cleansers. Detergents or cleansers preferably contain enzymes in total proportions of 1·10⁻⁶ to 5% by weight, based on the active protein. The protein concentration can be determined using known methods, such as the BCA procedure or the biuret procedure.

Of the proteases, those of the subtilisin type are preferred. Examples of those include Subtilisins BPN′ and Carlsberg, as well as the further-developed forms, Protease PB92, Subtilisins 147 and 309, the alkaline protease from, Subtilisin DY, and the subtilases Thermitase, Proteinase K and Proteases TWE and TW7, although they are no longer classified as subtilisins in the narrow sense.

Examples of amylases usable according to the invention include the α-amylases from, from from and, and the further developments of the aforementioned amylases that are improved for use in detergents or cleansers. The α-amylase from A 7-7 (DSM 12368) and the cyclodextrin glucanotransferase (CGTase) (DSM 9948) must be emphasized.

Lipases or cutinases can also be used according to the invention, especially because of their triglyceride-splitting activities, but also to generate peracids from suitable precursors. Those include, for instance, the lipases originally obtainable from or further-developed lipases, especially those with the amino acid replacement D96L. The cutinases originally isolated from and are also usable, for instance. Lipases or cutinases, the original enzymes of which were initially isolated from and can also be used.

It is also possible to use enzymes classified as hemicellulases. Those include, for instance, mannanases, xanthan lyases, pectin lyases (=pectinases), pectin esterases, pectate lyases, xyloglucanases (=xylanases), pullulanases and β-glucanases. Oxidoreductases, such as oxidases, oxygenases, catalases, peroxidases such as halo- chloro- bromo- lignin- glucose- or manganese peroxidases, dioxygenases or laccases (phenoloxidases, polyphenoloxidases) can also be used to increase the bleaching action. It is advantageous to add other, preferably organic, especially preferably aromatic, compounds that interact with the enzymes to increase the activity of the oxidoreductases involved (enhancers) or to assure electron flow in case of severely different redox potentials between the oxidizing enzymes and the dirt (mediators).

The enzymes can be used in any form established in the relevant art. They include, for instance, the solid preparations obtained by granulation, extrusion or lyophilization or, especially for liquid or gel agents, solutions of the enzymes, advantageously concentrated as much as possible, low in water, and/or mixed with stabilizers.

Alternatively, the enzymes can be encapsulated for either solid or liquid use forms, such as by spray drying or extrusion of the enzyme solution together with a preferably natural polymer or in the form of capsules, such as those in which the enzyme is enclosed in a solidified gel, or in those of the core-shell type, with which an enzyme-containing core is overcoated with a protective coating impermeable to water, air, and/or chemicals. Other active ingredients, such as stabilizers, emulsifiers, pigments, bleaches or dyes can also be applied in layered coatings. Such capsules are obtained by methods which are themselves, known, such as by shaking granulation or roll granulation, or in fluidized bed processes. Such granulations are advantageously low in dust and stable in storage because of the coating, such as by application of polymeric film-formers.

It is also possible to package two or more enzymes together so that a single granulation has multiple enzyme activities.

A protein, and/or an enzyme, can be protected, especially during storage, from damages such as inactivation, denaturation, or decomposition due to physical effects, oxidation or proteolytic hydrolysis. When the proteins and/or enzymes are obtained microbiologically, inhibition of proteolysis is especially preferred, especially if the medium contains proteases. Detergents or cleansers can contain stabilizers for that purpose. Preparation of such media is a preferred embodiment of the present invention.

It is preferable to use one or more enzymes and/or enzyme preparations, preferably solid protease preparations and/or amylase preparations, in proportions of 0.1 to 5% by weight, preferably from 0.2 to 4.5% by weight, and particularly from 0.4 to 4% by weight, based in each case on the total enzyme-containing agent.

Glass corrosion inhibiters prevent the appearance of clouding, shading and scratches, as well as of iridescence, of the surfaces of machine-washed glassware. Preferred glass corrosion inhibitors are derived from the group of magnesium and/or zinc salts and/or magnesium and/or zinc complexes.

The range of zinc salts preferred according to the invention, preferably organic acids, especially preferably organic carboxylic acids, extends from salts that are insoluble or poorly soluble in water, thus having solubilities less than 100 mg/liter, preferably less than 10 mg/liter, especially preferably less than 0.01 mg/liter, up to those salts having water solubilities greater than 100 mg/liter, preferably greater than 500 mg/liter, especially preferably greater than 1 g/liter, and particularly greater than 5 g/liter. (All solubilities at 20° C. water temperature) The first group of zinc salts includes, for instance, zinc citrate, zinc oleate and zinc stearate. The group of soluble zinc salts includes, for instance, zinc formate, zinc acetate, and zinc gluconate.

It is specially preferable to use least one zinc salt of an organic carboxylic acid, especially preferably a zinc salt from the group of zinc stearate, zinc oleate, zinc acetate, zinc lactate and/or zinc citrate. Zinc ricinoleate, zinc abietate and zinc oxalate are also preferred.

In the context of the present invention, the concentration of zinc salt in cleansing agents is preferably between 0.1 and 5% by weight, preferably between 0.2 and 4% by weight, and particularly between 0.4 and 3% by weight, or the concentration of zinc in the oxidized form (calculated as Zn⁺²) is between 0.01 and 1% by weight, preferably between 0.02 and 0.5% by weight, and particularly between 0.04 and 2% by weight, based on the total weight of the agent containing the glass corrosion inhibitor.

Corrosion inhibitors protect the materials being washed or the machine. In the area of machine dishwashing, agents that protect silver are of special importance. The substances well-known in the relevant art can be used. In general, silver-protecting agents selected from the group of triazoles, benzotriazoles, bisbenzotriazoles, aminotriazoles, alkylaminotriazoles and the transmission metal salts or complexes can be used. Use of benzotriazole and/or alkylaminotriazoles is specially preferred. 3-amino-5-alkyl-1,2,4-triazoles or their physiologically acceptable salts are especially preferred. It is particularly preferable to use those substances at a concentration of 0.001 to 10% by weight, preferably 0.0025 to 2% by weight, and especially preferably 0.01 to 0.04% by weight. Preferred acids for salt formation are hydrochloric acid, sulfuric acid, phosphoric acid, carbonic acid, sulfurous acid, and organic carboxylic acids such as acetic acid, glycolic acid, citric acid and succinic acid. 5-pentyl, 5-heptyl, 5-nonyl, 5-undecyl, 5-isononyl, 5-Versatic-10-acid alkyl-3-amino-1,2,4-triazoles and mixtures of them are quite specially active.

Agents containing active chlorine, which can distinctly reduce corrosion of silver surfaces, are also often found in cleanser formulations. Chlorine-free cleansers use, in particular, organic redox-active compounds containing oxygen and nitrogen, such as bifunctional and trifunctional phenols, e.g., hydroquinone, pyrocatechol, hydroxyhydroquinone, gallic acid, phloroglucinol, pyrogallol, or derivatives of those classes of compounds. Salt-like and complex-like inorganic compounds, such as salts of the metals Mn, Ti, Zr, Hf, V, Co and Ce are also often used. Here the transition metal salts selected from the group of manganese and/or cobalt salts and/or complexes are preferred. The cobalt(amine) complexes, the cobalt(acetate) complexes, the cobalt(carbonyl) complexes, and the chlorides of cobalt or manganese, and manganese sulfate are particularly preferred. Zinc compounds can also be used to prevent corrosion of the materials being washed.

Redox-active substances can be used instead of or in addition to the silver-protecting agents described above, such as the benzotriazoles. Those substances are preferably inorganic redox-active substances from the group of manganese, titanium, zirconium, hafnium, vanadium, cobalt and cerium salts and/or complexes, in which the metals are preferably in one of the oxidation levels II, III, IV, V or VI.

The metal salts or metal complexes used should be at least partially soluble in water. The counterions suitable for salt formation include all the ordinary singly, doubly, or triply negatively charged inorganic anions, e.g., oxide, sulfate, nitrate, or fluoride, as well as organic anions such as stearate.

Specially preferred metal salts and/or metal complexes are selected from the group MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ and mixtures of those, so that the metal salts and/or metal complexes selected from the group MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ are specially preferred for use.

The inorganic redox-active substances, especially metal salts or metal complexes, are preferably coated, i.e., completely covered with a material that is water-tight but easily soluble at the cleansing temperature, to prevent their premature decomposition or oxidation during storage. Preferred coating materials, which are applied by known processes, such as melt-coating processes according to Sandwik, from the food industry, are paraffins, microwaxes, waxes of natural origin such as carnauba wax, candelilla wax, beeswax, and high-melting alcohols such as hexadecanol, soaps or fatty acids.

The metal salts and/or metal complexes named are contained in cleansing agents preferably in a proportion of 0.05 to 6% by weight, preferably 0.2 to 2.5% by weight, based in each case on the total agent.

To make disintegration of premade moldings easier, it is possible to incorporate disintegration aids, “tablet disintegrants,” into these agents to shorten the disintegration time. Tablet disintegrants or disintegration accelerators are understood to mean excipients that provide for rapid disintegration of tablets in water or gastric fluid and for release of the pharmaceuticals in absorbable form.

These substances, which are also called “blasting” agents because of their effect, swell in water. They also increase in their own volume (swelling), but can also generate pressure by release of gases which cause the tablets to break down to small particles. Citric acid/carbonate systems are disintegrants known for a long time. Other organic acids can also be used. Examples of swelling disintegrants include, for instance, synthetic polymers such as polyvinylpyrrolidone (PVP) or natural polymers or modified natural substances such as cellulose and starch and their derivatives, alginates, or casein derivatives.

Disintegrants are preferably used in proportions of 0.5 to 10% by weight, preferably 3 to 7% by weight, and especially 4 to 6% by weight, based in each case on the total weight of the agent containing the disintegrant.

Cellulose-based disintegrants are used as preferred disintegrants, so that preferred detergents or cleansers contain such cellulose-based disintegrants in proportions of 0.5 to 10% by weight, preferably 3 to 7% by weight, and especially 4 to 6% by weight. Pure cellulose has the formal empirical composition (C₅H₁₀O₅)ₙ. Formally considered, it represents a β-1,4-polyacetal of cellobiose which in turn is made up of two molecules of glucose. Suitable celluloses consist of about 500 to 5,000 glucose units, and accordingly have average molecular weights of 50,000 to 500,000. Cellulose derivatives obtainable from cellulose by polymer-like reactions are also usable in the context of the present invention as cellulose-based disintegrants. Such chemically modified celluloses include, for example, products from esterifications or etherifications, in which hydroxyl hydrogen atoms are replaced. However, celluloses in which the hydroxyl groups have been replaced by functional groups not bonded through an oxygen atom can also be used as cellulose derivatives. For example, alkali celluloses, carboxymethylcellulose (CMC), cellulose esters and ethers, and aminocelluloses fall into the group of cellulose derivatives. The cellulose derivatives named are preferably not used alone as cellulose-based disintegrants, but in mixtures with cellulose. The concentrations of these mixtures of cellulose derivatives are preferably less than 50% by weight, and especially preferably less than 20% by weight based on the cellulose-based disintegrant. It is particularly preferred that pure cellulose free of cellulose derivatives be used as a cellulose-based disintegrant.

The cellulose used as a disintegrant is preferably not used in finely divided form but instead is converted into a coarse form, such as granulated or compacted before being mixed into the premixes to be compressed. The particles sizes of such disintegrants are usually greater than 200 μm, preferably with at least 9% by weight between 300 and 600 μm, and particularly with at least 90% by weight between 400 and 1,200 μm.

Microcrystalline cellulose can be used as another cellulose-based disintegrant or an ingredient of that component. This microcrystalline cellulose is obtained by partial hydrolysis of cellulose under conditions that attack and completely dissolve only the amorphous regions of the cellulose (about 30% of the total weight of the cellulose) while the crystalline regions (ca. 70%) are left undamaged. Subsequent disaggregation of the micro-fine cellulose resulting from the hydrolysis yields the microcrystalline cellulose, which has primary particle sizes of about 5 μm. They are compacted into granulations with mean particles sizes of 200 μm, for example.

The agents containing disintegrants contain 0.5 to 10% by weight, preferably 3 to 7% by weight, and particularly 4 to 6% by weight of the preferred disintegrants, preferably a cellulose-based disintegrant, preferably in granular, co-granulated or compacted form, based in each case on the total weight of the agent containing the disintegrant.

Effervescent systems that evolve gas can also be used by preference as tablet disintegrants according to the invention. The gas-evolving effervescence systems can consist of a single material that releases gas on contact with water. Magnesium peroxide is a particularly notable one of those compounds. It releases oxygen on contact with water. Usually, however, the gas-releasing effervescent systems are made up of at least two ingredients that react with each other to produce gas. Although numerous systems are conceivable and feasible, releasing, for example, nitrogen, oxygen or hydrogen, the effervescent systems utilized in detergents and cleansers are selected from both economic and ecological viewpoints. Preferred effervescent systems comprise alkali metal carbonates and/or bicarbonates and an acidifying agent that can release carbon dioxide from the alkali metal salts in aqueous solution.

Boric acid, alkali metal bisulfates, alkali metal dihydrogen phosphates and other inorganic salts are examples of acidifying agents that can be used to release carbon dioxide from the alkali salts in aqueous solution. However, it is preferable to use organic acidifying agents, with citric acid being a particularly preferred acidifying agent. In effervescent systems, the preferred acidifying agents are from the group of organic di-, tri- and oligo-carboxylic acids or mixtures of them.

Individual odor compounds, such as synthetic products of ester, ether, aldehyde, ketone, alcohol and hydrocarbon types can be used as perfume oils or odorants in the context of the present invention. However, use of mixtures of different odorants which together produce a pleasing fragrance is preferred. Such perfume oils can also contain natural odorant mixtures such as can be obtained from plant sources, such as pine, citrus, jasmine, patchouli, rose, or ylang-ylang oils.

An odorant must be volatile to be perceptible. The natures of the functional groups, the structure of the chemical compound, and its molecular weight have major effects on the volatility. For instance, most odorants have molecular weights up to about 200 Dalton, with molecular weights of 300 Dalton or more being exceptions. Because of the different volatilities of the odorants, the odor of a perfume or odorant made up of one or more odorants changes during its evaporation. Because of that, the fragrance impression is divided into “head notes” (top notes), “heart or middle notes” (heart notes or body) and “base notes” (end notes or dry-out). As the fragrance impression depends largely on the intensity of the odor, the top note of a perfume or odorant does not consist solely of highly volatile compounds, while the end notes consist mostly of the less volatile odorants, that is, the tenacious odorants. In formulation of perfumes, for instance, the more highly volatile odorants can be bound to certain fixatives, preventing overly rapid evaporation. In the subsequent classification of odorants as “highly volatile” or “tenacious” odorants, therefore, nothing is said about the odor impression or whether the corresponding odorant is perceived as a top note or a middle note.

The odorants can be processed directly; but it can also be advantageous to apply the odorants to carriers, which give a longer-lasting odor by releasing the odor slowly. Cyclodextrins, for instance, are proven as such carrier materials. The cyclodextrin-perfume complex can also be coated with other aids.

Selection of preferred colorants presents no problem to those skilled in the art. Preferred colorants have high storage stability and are not sensitive to the other ingredients of the medium or to light. They have no significant substantivity for the substrates that will be treated with the agent containing the colorants, such as textiles, glass, ceramic or plastic dishes so that those substrates are not stained.

In choosing a colorant, one must take care that the colorant has high storage stability and insensitivity to light, as well as no excessive affinity to glass, ceramic or plastic dishes. In selection of suitable colorants, one must at the same time remember that colorants have different stabilities to oxidation. In general, colorants insoluble in water are more stable to oxidation than are water-soluble colorants. The concentration of the colorant in the detergent or cleanser depends on its solubility and so also on its sensitivity to oxidation. Colorant concentrations in the range of a few hundredths to thousands of one percent by weight are typically chosen for highly water-soluble colorants. Suitable concentrations in detergents or cleansers of pigment colorants that are preferred for their brilliance but are less water-soluble are, on the other hand, typically a few thousandths to tens-thousandths of one percent by weight.

Colorants that can be destroyed by oxidation in the washing process are preferred, as well as mixtures of them with suitable blue colorants, known as bluing agents. It has proved to be advantageous to use colorants that are soluble in water, or in liquid organic substances at room temperature. Anionic colorants such as anionic nitroso dyes, for example, are preferred.

In addition to the components that have been described extensively, the detergents and cleansers can contain other ingredients that further improve the application-technology and/or aesthetic properties of those agents. Preferred agents contain one or more substances from the group of electrolytes, pH-adjusting agents, fluorescent materials, hydrotopes, foam inhibitors, silicone oils, antiredeposition agents, optical brighteners, graying inhibitors, substances to prevent shrinkage, crease-resistance agents, agents to prevent color transfer, antimicrobial agents, germicides, fungicides, antioxidants, antistatics, ironing aids, repellent agents and impregnants, agents to prevent moisture absorption and slipping, and UV absorbers.

A wide range of quite different salts from the group of inorganic salts can be used as electrolytes. The preferred cations are those of alkali and alkaline earth metals. Preferred anions are the halides and sulfates. From the viewpoint of production engineering, it is preferred to use NaCl or MgCl₂ in the detergents or cleansers.

Use of pH-adjusting agents may be indicated to bring the pH of detergents or cleansers into the desired range. All the known acids and bases are usable here as long as their use is not forbidden by applications engineering or ecological reasons, or for consumer protection. The proportion of these adjusting agents usually does not exceed 1% by weight of the total formulation.

Substances that can be considered as foam inhibitors include, among others, soaps, oils, fats, paraffins or silicone oils. They can optionally be applied to carrier materials. Examples of suitable carrier materials include inorganic salts such as carbonates or sulfates, cellulose derivatives, or silicates, and mixtures of those materials. Materials preferred in the context of the present invention contain paraffins, preferably unbranched paraffins (n-paraffins) and/or silicones, preferably linearly polymeric silicones which have structures indicated by the formula (R₂SiO)ₓ and which are also known as silicone oils. These silicone oils are usually clear, colorless, neutral, odor-free hydrophobic liquids having molecular weights from 1,000 to 150,000 and viscosities of 10 to 1,000,000 mPa-s.

Suitable antiredeposition agents, also called soil repellents, are, for example, nonionic cellulose ethers such as methylcellulose and methylhydroxypropylcellulose, having a proportion of 15 to 30% by weight methoxy groups and 1 to 15% by weight hydroxypropyl groups, based in each case on the nonionic cellulose ether. They can also be polymers of phthalic acid and/or terephthalic acid or their derivatives, known in the relevant art, especially polymers of ethylene terephthalates and/or polyethylene glycol terephthalates, or anionically and/or nonionically modified derivatives of them. Of those, the sulfonated derivatives of phthalic acid and terephthalic acid polymers are particularly preferred.

Optical brighteners (called “whiteners”) can be added to the detergents or cleansers to eliminate graying and yellowing of the textiles treated. These substances adsorb to the fibers and produce a brightening and simulated bleaching effect by converting invisible ultraviolet radiation into visible longer-wavelength light. Thus, the ultraviolet light absorbed from the sunlight is radiated as a weak bluish fluorescence which, combined with the yellowing tone of the grayed or yellowed laundry gives pure white. Suitable compounds are derived, for example, from the substance classes of the 4,4′-diamino-2,2′-stilbenedisulfonic acids (flavonic acids), 4,4′-distyrylbiphenylenes, methylumbelliferones, coumarins, dihydroquinolones, 1,3-diarylpyrazolines, naphthalic acid imides, benzoxazole, benzisoxazole and benzimidazole systems, and pyrene derivatives substituted with heterocycles.

Graying inhibitors have the function of holding the dirt removed from the fibers suspended in the wash water and so preventing the dirt being adsorbed again. Water-soluble colloids, usually organic in nature, are suitable for this, such as the water-soluble salts of polymeric carboxylic acids, glue, gelatins, salts of ether sulfonic acids of starch or cellulose, or salts of acidic sulfuric acid esters of cellulose or starch. Water-soluble polyamides containing acidic groups are also suitable for this purpose. Soluble starch preparations and others of the starch products mentioned above can also be used, for instance, degraded starch, aldehyde starches, etc. Polyvinylpyrrolidone can also be used. Other usable graying inhibitors are cellulose ethers such as carboxymethylcellulose (Na salt), methylcellulose, hydroxyalkylcellulose and mixed ethers such as methylhydroxyethylcellulose, methylhydroxypropylcellulose, methylcarboxymethylcellulose and mixtures of them.

As textile fabrics, especially those made of rayon, viscose, rayon staple, cotton, and mixtures of them, have a tendency to wrinkle, because the individual fibers are susceptible to bending, kinking, pressing and crushing transversely to the fiber direction, synthetic anti-creasing agents can be used. Those include, for example, synthetic products based on fatty acids, fatty acid esters, fatty acid amides, fatty acid alkylol esters, fatty acid alkylolamides or fatty alcohols, usually reacted with ethylene oxide, or products based on lecithin or modified phosphoric acid esters.

Repellent and impregnating processes act to provide the textiles with substances that prevent deposition of dirt or make it easier to wash out. Preferred repellents and impregnants are perfluorinated fatty acids, also in the form of their aluminum and zirconium salts, organic silicates, silicones, polyacrylic acid esters with perfluorinated alcohol components or polymerizable compounds coupled with perfluorinated acyl or sulfonyl groups. They may also contain antistatics. The dirt-repellent finish with repellents and impregnants is often classified as an easy-care finish. Penetration of the impregnants in the form of solutions or emulsions of the active substances concerned can be made easier by addition of wetting agents, which reduce the surface tension. Repellents and impregnants are also used in the water-repellent finishing of textile goods, tents, awnings, leather, etc. With that treatment the pores of the fabric are not closed, in contrast to waterproofing, so that the material remains breathable (hydrophobizing). The hydrophobizing agents used for hydrophobizing materials act by coating the materials such as textiles, leather, paper, wood, etc., with a very thin layer of hydrophobic groups such as long alkyl chains or siloxane groups. Examples of suitable hydrophobizing agents include paraffins, waxes, metal soaps, etc., with additions of aluminum or zirconium salts; quaternary ammonium compounds with long-chain alkyl groups; urea derivatives, fatty acid-modified melamine resins, complex chromium salts, silicones, organotin compounds and glutardialdehyde, as well as perfluorinated compounds. The hydrophobized materials do not feel oily, but nevertheless water droplets bead up on them, as on oiled materials, without wetting them. Thus, for example, silicone-impregnated textiles have a soft hand and repel water and dirt. Spots from ink, wine, fruit juices and the like can be removed more easily.

Antimicrobial agents can be used to combat microorganisms. Here one distinguishes among bacteriostats and bacteriocides, fungistats and fungicides, etc., depending on the antimicrobial spectrum and the mechanism of action. Examples of important materials of these groups are benzalkonium chlorides, alklaryl sulfonates, halophenols and phenylmercuric acetate. Use of these compounds can also be avoided entirely.

The agents can contain antioxidants to prevent undesired changes in the detergents or cleansers and/or treated textiles due to the effect of oxygen and other oxidative processes. Examples of those compounds include substituted phenols, hydroquinones, pyrocatechols and aromatic amines, as well as organic sulfides, dithiocarbamates, phosphites and phosphonates.

Addition of antistatics can give elevated wearing comfort. Antistatics increase the surface conductivity, allowing charges developed to drain off better. External antistatics are usually substances with at least one hydrophilic molecular ligand. They give the surfaces a more or less hygroscopic film. These antistatics, which are at least surface-active, can be classified as nitrogen-containing (amines, amides, quaternary ammonium compounds), phosphorus-containing (phosphoric acid esters) and sulfur-containing (alkyl sulfonates, alkyl sulfates) antistatics. Lauryl (or stearyl) dimethylbenzylammonium chlorides are likewise suitable as antistatics for textiles or as additives to cleansers, so as also to produce a softening effect.

Softening rinses can be used to care for the textiles and to improve the textile characteristics like a softer hand (softening) and reduced electrostatic charging (better wearing comfort). The active ingredients in softening rinse formulations are “esterquats,” quaternary ammonium compounds with two hydrophobic groups, such as distearyldimethylammonium chloride. However, because that is not sufficiently biodegradable, it is increasingly being replaced by quaternary ammonium compounds that contain, in their hydrophobic groups, ester groups as points of attack for biological degradation. Such “esterquats” with improved biodegradability are obtainable, for instance, by esterifying mixtures of methyldiethanolamine and/or triethanolamine with fatty acids and then quaternizing the reaction products, in a manner which is itself known, with alkylating agents. Dimethylol ethyleneurea is also suitable as a finish.

Silicone derivatives can be used to improve ability to absorb water, the water regain of the treated textiles, and to make ironing of the treated textiles easier. Those also improve the ability to rinse out the detergents or cleansers because of their foam-inhibiting properties. Examples of preferred silicone derivatives include polydialkyl or alkylaryl siloxanes, in which the alkyl groups have one to five C atoms and are partially or completely fluorinated. Preferred silicones are polydimethylsiloxanes, which can optionally be derivatized and then have aminofunctional or quaternary groups or have Si—OH—, Si—H or Si—Cl bonds. Other preferred silicones are the polyalkylene oxide-modified polysiloxanes, which are polysiloxanes with polyethylene glycols, for example, and the polyalkylene oxide-modified dimethylpolysiloxanes.

Finally, UV absorbers can also be used according to the invention. They are absorbed by the treated textiles and improve resistance of the fibers to light. Examples of compounds with those desired properties are those that act by non-radiative inactivation and derivatives of benzophenones with substituents in the 2- and/or 4-position. Substituted benzotriazoles, acrylates substituted by phenyl in the 3-position (cinnamic acid derivatives), optionally having cyano groups in the 2-position, salicylates, organic Ni complexes, and natural substances such as umbelliferone and the body's own urocanic acid are also suitable.

Protein hydrolyzates, because of their fiber-preservative action, are other active substances from the field of detergents or cleansers that are preferred in the context of the present invention. Protein hydrolyzates are mixtures of products obtained by acidic, basic, or enzmatically catalyzed degradation of proteins. Protein hydrolyzates of both animal and plant origin can be used according to the invention. Examples of animal protein hydrolyzates include elastin, collagen, keratin, silk and milk protein hydrolyzates, which can also be in the form of salts. It is preferred according to the invention to use protein hydrolyzates of plant origin, such as soy, almond, rice, pea, potato and wheat protein hydrolyzates. Although use of the protein hydrolyzates as such is preferred, amino acid mixtures obtained in other ways, or individual amino acids such as arginine, lysine, histidine, or pyroglutamic acid can optionally be used. It is likewise possible to use derivatives of the protein hydrolyzates, such as in the form of their fatty acid condensation products.

1. A packaging system for measured units of detergents or cleansers, comprising
a) a primary packaging system in the form of a number (n)>2 of water-insoluble bags, each of which bags contains a number (x)>2 of measured units of detergent or cleanser; and
b) a secondary packaging system in the form of a water-insoluble bag which contains the (n) water-insoluble bags of the primary packaging system.

2. The packaging system according to claim 1 wherein the measured units of detergents or cleansers are filled water-soluble or water-dispersible bags.

3. The packaging system according to claim 1 wherein the measured detergent or cleanser units comprise a compressed molding and a water-soluble film adhesively bonded to that molding.

4. The packaging system according to claim 1 wherein the measured units of detergent or cleanser contain more than 4% by weight sodium percarbonate, based on the total weight of the detergent or cleanser.

5. The packaging system according to claim 1 wherein the measured units of detergent or cleanser contain 0.5 to 8% by weight of nonionic surfactant, based on the total weight of the measured units of detergent or cleanser.

6. The packaging system according to claim 1, wherein the water-insoluble bags of the primary packaging system each contain a number (x)>3 of the measured units of detergent or cleanser.

7. The packaging system according to claim 1 wherein the primary packaging system comprises a number (n)>3 of water-insoluble bags.

8. The packaging system according to claim 1 wherein the number (n) of the water-insoluble bags of the primary packaging system and the number (x) of the measured units of detergent or cleanser contained in each of those bags do not differ by more than 3.

9. The packaging system according to claim 1 wherein the primary and/or the secondary packaging system(s) has or have a moisture permeation rate of 0.1 g/m²/day to less than 20 g/m² per day if the packaging system is stored at 23° C. and a relative equilibrium moisture content of 85%.

10. The packaging system according to claim 1 wherein at least one water-insoluble bag of the primary packaging system and/or of the water-insoluble bag of the secondary packaging system is inflated.

11. The packaging system according to claim 1 wherein at least one of the water-insoluble bags of the primary packaging system and/or of the water-insoluble bags of the secondary packaging system is filled with a gas having a composition different from that of the ambient air.

12. The packaging system according to claim 1 wherein at least one of the water-insoluble bags of the primary packaging system and/or the water-insoluble bags of the secondary packaging system is vacuum-sealed.

13. The packaging system according to claim 1 wherein at least one of the water-insoluble bags of the primary packaging system and/or of water-insoluble bags of the secondary packaging system is selected from the group consisting of a stand-up pouch, a gusseted bag, a satchel bag, and a flowpack.

14. The packaging system according to claim 1 wherein at least one of the water-insoluble bags of the primary packaging system and/or of the water-insoluble bags of the secondary packaging system has a reclosable opening.

15. A packaging system for measured units of detergents or cleansers, comprising
a) a primary packaging system in the form of a number (n)>2 of water-insoluble bats, each of which bags contains a number (x)>2 of measured units of detergent or cleanser and is filled with a gas having a composition different from that of the ambient air; and
b) a secondary packaging system in the form of a water-insoluble bag which contains the (n) water-insoluble bags of the primary packaging system.

16. The packaging system according to claim 15, wherein the water-insoluble bags of the primary packaging system each contain a number (x)>3 of the measured units of detergent or cleanser.

17. The packaging system according to claim 15 wherein the primary packaging system comprises a number (n)>3 of water-insoluble bags.

18. The packaging system according to claim 15 wherein the number (n) of the water-insoluble bags of the primary packaging system and the number (x) of the measured units of detergent or cleanser contained in each of those bags do not differ by more than 3.

19. The packaging system according to claim 15 wherein the primary and/or the secondary packaging system(s) has or have a moisture permeation rate of 0.1 g/m²/day to less than 20 g/m² per day if the packaging system is stored at 23° C. and a relative equilibrium moisture content of 85%.

20. A packaging system for measured units of detergents or cleansers, comprising
a) a primary packaging system in the form of a number (n)>2 of water-insoluble bags, each of which bags contains a number (x)>2 of measured units of detergent or cleanser in the form of tablets; and
b) a secondary packaging system in the form of a water-insoluble bag which contains the (n) water-insoluble bags of the primary packaging system.
